(19) United States
(12) Patent Application Publication
(10) Pub. No.: US 2019/0221116 A1
(43) Pub. Date: Jul. 18, 2019

(54) Traffic Control Utilizing Vehicle-Sourced Sensor Data, and Systems, Methods, and Software Therefor

(71) Applicant: Xtelligent, Inc., Los Angeles, CA (US)

(72) Inventors: Andrew Powch, Huntington Beach, CA (US); Michael Lim, Los Angeles, CA (US)

(21) Appl. No.: 16/244,620

(22) Filed: Jan. 10, 2019

Related U.S. Application Data
(60) Provisional application No. 62/616,891, filed on Jan. 12, 2018.

(51) Int. Cl. G08G 1/08; G08G 1/081; G08G 1/01

(52) U.S. Cl. CPC G08G 1/08; G08G 1/0145; G08G 1/0112; G08G 1/081

(57) ABSTRACT

Traffic control based on sensor data acquired using vehicle-borne sensors. Such sensor data can be used to control right-of-way priority for any one or more of various traffic objects sensed by the vehicle-borne sensors. In some embodiments vehicle-sourced sensor data is used to control traffic signals at one or more signalized roadway intersections. In some embodiments, a traffic-object awareness system utilizes at least one traffic-object-state algorithms to classify objects proximate to an intersection and to determine a current state of each object. The traffic-object-awareness system uses such classification and state information in executing a travel-prioritization algorithm to determine whether travel priority should be given to any one or more traffic objects identified within the classified objects. When the traffic-object-awareness system determines that travel priority should be given, it generates and sends a call signal to a traffic signal controller.

### RELATED APPLICATION DATA

This application claims the benefit of priority of U.S. Provisional Patent Application Ser. No. 62/616,891, filed Jan. 12, 2018, and titled “PEDESTRIAN/BICYCLE AWARENESS SYSTEM, METHODS, AND SOFTWARE”, which is incorporated by reference herein in its entirety.

### FIELD OF THE INVENTION

The present invention generally relates to the roadway traffic control. In particular, the present invention is directed to traffic control utilizing vehicle-sourced sensor data, and systems, methods, and software therefor.

### BACKGROUND

Signalized traffic intersections serve to regulate the flow of vehicles, pedestrians, bicycles, and other modes of transportation. Each mode of transportation relies on signals to regulate their movement. Motor vehicles, bicyclists, and other road vehicles legally determine their crossing based on the traditional roadway traffic signals with their red, green, and yellow lights. If no pedestrian-specific signals are provided, pedestrians typically follow the green phase lighting in their desired direction of travel. If pedestrian-specific signals are provided, pedestrians should follow the “walk” and “don't walk” signals, often, respectively, a light in the shape of a walking person and an orange or red light in the shape of an upraised hand. Current state of the art allows a pedestrian to push a button which places a “call” to the traffic signal controller, which then provides a protected “walk” signal and pathway. This is sometimes combined with an auditory sound for visually impaired pedestrians to safely transit the intersection.

### SUMMARY OF THE DISCLOSURE

In one implementation, the present disclosure is directed to a method of controlling a signalized traffic intersection based on presence of one or more traffic objects in proximity to the signalized traffic intersection, wherein the signalized traffic intersection includes a plurality of traffic signals controlled by a traffic signal controller. The method being executed by a traffic-object-awareness system includes continually obtaining object-location information based on sensor data from sensors located onboard one or more sensor-equipped vehicles in proximity to the signalized traffic intersection, wherein the object-location information contains information locating one or more traffic objects at or proximate to the signalized traffic intersection; executing one or more traffic-object-state algorithms that use the object-location information for each of the one or more traffic objects and an object classification for each of the one or more traffic objects to determine a current state of at least one of the one or more traffic objects; executing a travel-prioritization algorithm to determine whether to give at least one of the one or more traffic objects travel priority; when the travel-prioritization algorithm has determined that travel priority should be given to at least one of the one or more traffic objects, generating a call signal configured to cause the traffic signal controller to control the plurality of traffic signals to give the travel priority to the at least one of the one or more traffic objects; and transmitting the call signal to the traffic signal controller.

In another implementation, the present disclosure is directed to a machine-readable storage medium containing machine-executable instructions for performing a method of controlling a signalized traffic intersection based on presence of one or more traffic objects in proximity to the signalized traffic intersection, wherein the signalized traffic intersection includes a plurality of traffic signals controlled by a traffic signal controller. The method includes continually obtaining object-location information based on sensor data from sensors located onboard one or more sensor-equipped vehicles in proximity to the signalized traffic intersection, wherein the object-location information contains information locating one or more traffic objects at or proximate to the signalized traffic intersection; executing one or more traffic-object-state algorithms that use the object-location information for each of the one or more traffic objects and an object classification for each of the one or more traffic objects to determine a current state of at least one of the one or more traffic objects; executing a travel-prioritization algorithm to determine whether to give at least one of the one or more traffic objects travel priority; when the travel-prioritization algorithm has determined that travel priority should be given to at least one of the one or more traffic objects, generating a call signal configured to cause the traffic signal controller to control the plurality of traffic signals to give the travel priority to the at least one of the one or more traffic objects; and transmitting the call signal to the traffic signal controller.

In yet another implementation, the present disclosure is directed to a method of determining a location of an object via a plurality of vehicles in proximity to the object. The method includes sensing presence of the object using one or more first sensors located onboard a first vehicle of the plurality of vehicles; generating first object-location data for the object based on the sensing of the object; receiving, from at least one second vehicle of the plurality of vehicles, second object-location data for the object generated onboard the at least one second vehicle based on sensing of the presence of the object by one or more second sensors aboard the at least one second vehicle; determining best-location data for the object using the first object-location data and the second object-location data; and sharing the best-location data among the plurality of vehicles.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is a high-level schematic diagram of an example implementation of a traffic-object-awareness system of the present disclosure is deployed for an intersection to allow intersection-control infrastructure to control flow of traffic through the intersection;

FIG. 1B is a flow diagram illustrating an example method of controlling a signalized traffic intersection;

FIG. 2 is a high-level block diagram of general features common to the various scenarios depicted in FIGS. 3 to 11;

FIG. 3 is a diagram illustrating scenario in which three sensor-equipped vehicles acquire data used for identifying and locating a pedestrian in proximity to an intersection;

FIG. 4 is a diagram illustrating a scenario in which the sensor-equipped vehicles of FIG. 3 are transmitting sensor data to a traffic-object-awareness system;

FIG. 5 is a diagram illustrating a scenario in which two sensor-equipped vehicles are detecting pedestrians in a group of pedestrians;

FIG. 6 is a diagram illustrating a scenario in which three sensor-equipped vehicles are each detecting and locating a single pedestrian in connection with determining a calculated location for the pedestrian;

FIG. 7 is a diagram illustrating a scenario in which two sensor-equipped vehicles are each detecting and locating pedestrians in a group of pedestrians in connection with determining a calculated location for each of the pedestrians in the group;

FIG. 8 is a diagram illustrating a scenario in which the intersection is being automatically controlled based on determined movement and orientation of a pedestrian;

FIG. 9 is a diagram illustrating a scenario in which the intersection is being automatically controlled based on determined movement and direction of travel of a bicycle travelling straight across the intersection;

FIG. 10 is a diagram illustrating a scenario in which the intersection is being automatically controlled based on determined movement and direction of travel of a bicycle making a left-hand turn in the intersection;

FIG. 11 is a diagram illustrating a scenario in which the intersection is being automatically controlled based on determined jaywalking by a pedestrian;

FIG. 12 is a diagram illustrating a plurality of sensor-equipped vehicles communicating with one another so as to determine locations of two pedestrian; and

FIG. 13 is schematic diagram of an example computing system that can be used to implement any one or more algorithms and functionalities disclosed herein.

### DETAILED DESCRIPTION

Vehicles transiting roadways are becoming increasingly connected and autonomous, and are increasingly equipped with sensors used to understand the geometry of their local environments in great detail. This includes the location of lanes, curbs, signs, intersections, other vehicles (cars, buses, motorcycles, trucks, etc.), bicycles, animals, pedestrians, etc. The sensors currently used with equipped vehicles are radar-based, image/camera-based, and light imaging, detection, and ranging (LIDAR)-based, although the scope of this disclosure considers all future embodiments of vehicle-borne sensors that detect the locations of and/or identify the types of objects around the sensor-equipped vehicle.

In some embodiments, the present disclosure is directed to utilizing sensor data obtained from one or more sensor-equipped vehicles located proximate to a signalized roadway intersection (hereinafter simply “intersection”) to control intersection-control infrastructure for controlling the flow of traffic at that intersection. Incorporating vehicle-sourced sensor data that locates traffic objects in and/or around the intersection into the control scheme used to control the intersection-control infrastructure (e.g., roadway and/or pedestrian signal) can improve the functioning of the intersection in terms of, for example, optimizing flow, reducing wait times, and/or increasing safety for the traffic objects using the intersection. For consistency and clarity, the following terminology is herein and in the appended claims:

A “signalized traffic intersection,” or simply “intersection,” is any intersection where movement of traffic objects is controlled using traffic signals that continually give travel priority to traffic objects in alternating directions of travel. Examples of intersections are three-way, four-way, and five-way roadway intersection that include roadway traffic signals and/or pedestrian traffic signals, such as of the types noted above in the Background section, among other types of traffic signals.

A “traffic object” is any object, or combination of objects, that constitute(s) objects desiring to traverse or otherwise move through the intersection. Examples of traffic objects include, but are not limited to, motor vehicles (cars, trucks, buses, motorcycles, motorized scooters, self-balancing mobility devices, motorized wheelchairs, etc.), human- or animal-powered vehicles (bicycles, horse and buggies, skateboards, human-powered scooters, baby carriages, etc.), pedestrians, animals (e.g., horses, assistance animals (e.g., “seeing-eye dogs), etc.), and any combination thereof, among others. Fundamentally, there is no limitation on the type of traffic object other than it be a movable object in which the entity in control of the traffic object has an intent to move through the intersection. It is noted that while traffic objects are the objects of interest for many applications of the object-location technology disclosed herein, this object-location technology can also or alternatively be used to locate static objects, such as signs, poles, curbs, fire hydrants, among many other objects within the fields of view of vehicle-borne sensors used to implement various aspects of the present disclosure.

“Traffic-control infrastructure” means any device(s) and equipment deployed for controlling the flow of traffic within an intersection, including roadway signals (e.g., traffic lights) for signaling traffic objects in roadway travel lanes of the intersection, pedestrian signals (e.g., walk/don't walk lights and sounds) for signaling traffic objects intending to traverse across the roadway travel lane(s) of the intersection, and one or more signal controllers for controlling the roadway and/or pedestrian signals. In many cases, a signal controller is physically located proximate to the intersection under consideration. However, in other cases, a signal controller is physically located away from the intersection and may also control more than one intersection. In yet other cases, an intersection-level signal controller may be in communication with a higher-level controller that controls multiple intersection. In all cases, a control scheme of the present disclosure that utilized vehicle-sourced sensor data is considered to act upon “a signal controller” whether the signal controller is a standalone controller or is a collective of multiple signal controllers.

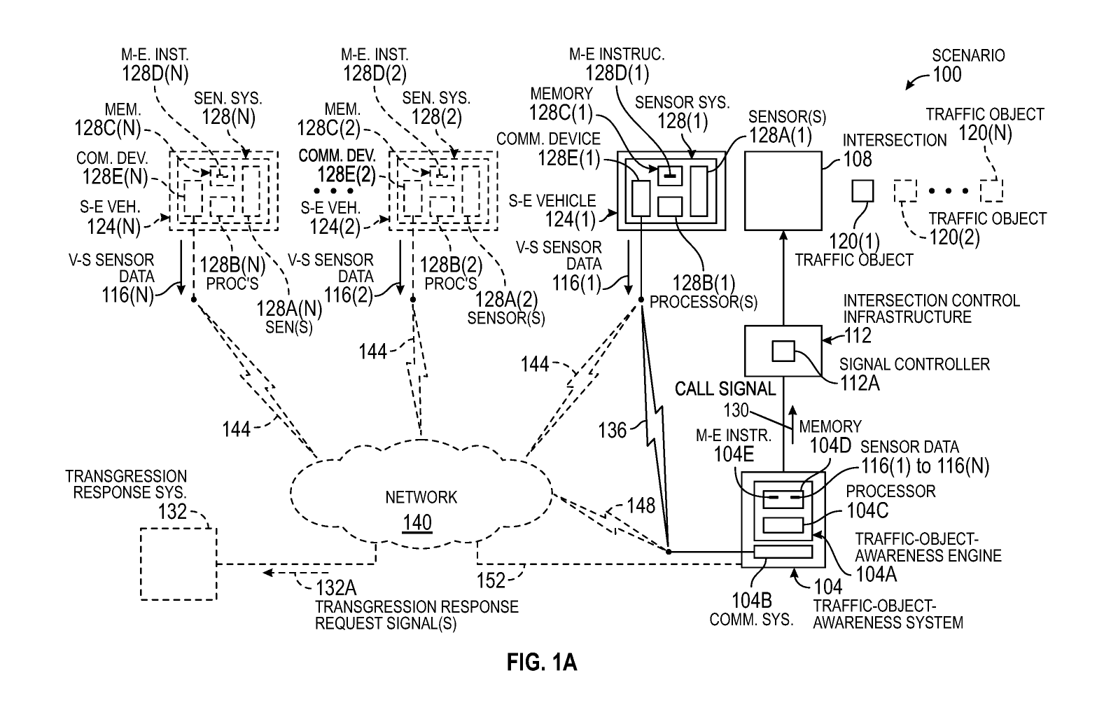

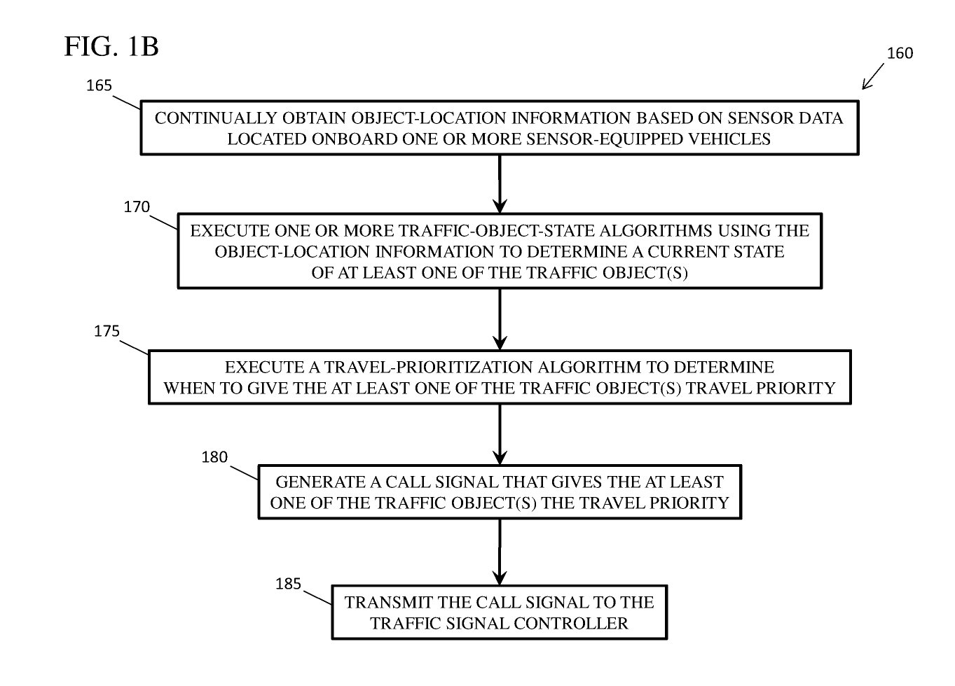

With the foregoing in mind, FIG. 1A illustrates an example scenario 100 in which a traffic-object-awareness system 104 of the present disclosure is deployed for an intersection 108 to allow intersection-control infrastructure 112 to control, as needed and/or desired, flow of traffic at least partially based on vehicle-sourced sensor data 116(1) to 116(N) for one or more traffic objects 120(1) to 120(N) located in or proximate to the intersection. In context of this disclosure and the claims appended hereto, “proximate to” relative to an intersection, here intersection 108, means that a traffic object is within such a distance from the intersection and/or moving toward the intersection such that it is reasonable for traffic-object-awareness system 104 and/or intersection-control infrastructure 112 to consider that traffic object's location and/or movement direction in controlling flow within the intersection. Because intersection geometries, types of traffic objects, signalization, and flow volumes, among other things, can vary greatly, it is not possible to generically define “proximate to” in the context of traffic objects. However, those skilled in the art will understand the bounds of “proximate to” given a specific intersection and corresponding control parameters.

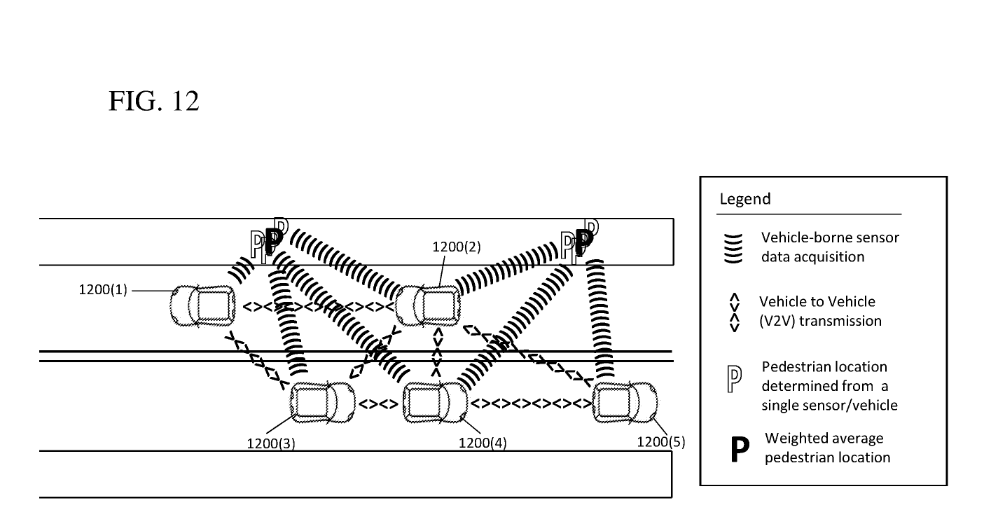

Traffic-object-awareness system 104 obtains vehicle-sourced sensor data 116(1) to 116(N) from one or more corresponding sensor-equipped vehicles 124(1) to 124(N) that are close enough to intersection 108 to perceive one or more of traffic objects 120(1) to 120(N) that are within or proximate to the intersection. Each sensor-equipped vehicle 124(1) to 124(N) includes a sensor system 128(1) to 128(N) that includes one or more sensors (collectively represented in corresponding respective sensor systems as sensors 128A(1) to 128A(N)) that acquire measurements and/or other information, such as imaging information, that can be used to locate and/or identify one or more of traffic objects 120(1) to 120(N) within or proximate to intersection 108. Depending on the configuration of each sensor system 128(1) to 128(N), it may provide corresponding vehicle-sourced sensor data 116(1) to 116(N) to traffic-object-awareness system 104 as raw sensor data or as processed sensor data. In one example, processed sensor data may include an object identification, relative object location, and vehicle coordinates (e.g., from a global positioning system (GPS) or other system for determining vehicle coordinates) for each object (e.g., traffic object 120(1) to 120(N)) it identifies. In some cases, and as described below in more detail relative to FIG. 12, two or more sensor-equipped vehicles 124(1) to 124(N) may collaborate with one another to identify a most-likely location for each of at least some objects (e.g., traffic objects 120(1) to 120(N)) they identify. Examples of sensors 128A(1) to 128A(N) that may be aboard each sensor-equipped vehicle 124(1) to 124(N) include, but are not limited to, radar-based sensors, image/camera-based sensors, and LIDAR-based sensors, among others. As noted above, the type(s) of sensors 128A(1) to 128A(N) aboard each sensor-equipped vehicle 124(1) to 124(N) is/are not critical; important criteria that they are able to sense, identify, and/or locate the desired traffic object(s) 120(1) to 120(N).

In addition to sensor(s) 128A(1) to 128A(N), each sensor system 128(1) to 128(N) may include at least one processor (collectively represented as processor 128B(1) to 128B(N)) and memory 128C(1) to 128C(N). Each processor 128B(1) to 128B(N) is configured to execute machine-executable instructions 128D(1) to 128(N), contained in memory 128C(1) to 128C(N), that provide and control the functionality of the corresponding sensor system 128(1) to 128(N). Examples of functionalities that each processor 128B(1) to 128B(N) and machine-executable instructions 128D(1) TO 128D(N) may provide include, but are not limited to, acquiring raw data from onboard sensor(s) 128A(1) to 128A(N), processing the raw data from the onboard sensor(s), controlling communications with traffic-object-awareness system 104, receiving object type and location data from other sensor systems aboard other sensor-equipped vehicles 124(1) to 124(N), and coordinating and otherwise communicating with sensor systems of other sensor-equipped vehicles, among other things. Those skilled in the art will readily appreciate the necessary functionality depending on the design and configuration of the sensor system 128(1) to 128(N) and will understand the corresponding machine-executable instructions for providing that functionality.

In this example, traffic-object-awareness system 104 includes a traffic-object-awareness engine 104A and a communications system 104B. At a high level, traffic-object-awareness engine 104A receives vehicle-sourced sensor data 116(1) to 116(N) via communications system 104B, processes that data, generates one or more call signals (represented collectively at call signal 130), and causes communications system 104B to send the call signal to intersection-control infrastructure 112 for intersection 108. Sensor data 116(1) to 116(N) may be in any one or more of a variety of forms depending on the configuration(s) of the corresponding sensor(s) 128A(1) to 128A(N). For example and as noted above, sensor data 116(1) to 116(N) may be, for example, raw sensor data or sensor data that processor 128B(1) to 128B(N) has/have conditioned to be in a desired form different from the raw sensor data received from sensors 128A(1) to 128A(N). Traffic-object-awareness engine 104A may comprise one or more processors (collectively represented as processor 104C), memory 104D, and machine-executable instructions 104E that work together to provide the requisite functionalities.

Communications system 104B may include any type(s) of communications device(s) suitable for the various communications that traffic-object-awareness system 104 performs during operation. For example, if sensor-equipped vehicles 124(1) to 124(N) communicate with one another via a vehicle-to-vehicle (V2V) type radio system (e.g., a dedicated short-range communications (DSRC) radio system or a 5G system) and/or communicate with an instantiation of traffic-object-awareness system 104 that is part of traffic infrastructure of intersection 108 via a vehicle-to-infrastructure (V2I) type radio system, then communications system 104B may include a V2V transceiver and/or a V2I transceiver (not shown) operating on the same frequency(ies) as corresponding transceivers aboard the sensor-equipped vehicles and/or traffic infrastructure. As another example, if sensor-equipped vehicles 124(1) to 124(N) communicate with traffic-object-awareness system 104 via an Internet-based communications system, for example a WI-FI® radio-based system or a cellular communications system, communications system 104B includes a network device (not shown). Correspondingly, each sensor system 128(1) to 128(N) may also be considered to include at least one communications device (collectively represented as communications device 128E(1) to 128E(N)). Communications device 128C(1) to 128C(N) may comprise any one or more communications devices suitable for the communications protocol(s) utilized. For example, each communications device 128C(1) to 128C(N) may include V2V type radio system, a cellular communications system, and/or a WI-FI® radio-based system, among others.

Communications system 104B also communicates with intersection-control infrastructure 112 and, so, includes whatever type of communications device that is compatible with the signal controller 112A of the intersection-control infrastructure. For example, if intersection-control infrastructure 112 and traffic-object-awareness system 104 are separate devices, they may communicate via a wired or wireless connection (not shown). In such embodiments, communications system 104B may include a suitable wired or wireless communications port or device. As another example, if intersection-control infrastructure 112 and traffic-object-awareness system 104 are integrated with one another, such as by being integrated in the same hardware+software system, communications system 104B may comprise memory locations and software and hardware for accessing those memory locations. Those skilled in the art will understand how communications system 104B needs to be configured to communicate with sensor-equipped vehicles 124(1) to 124(N) and intersection-control infrastructure 112 to suit the communications protocols and means of sensor-equipped vehicles 124(1) to 124(N) and intersection-control infrastructure 112.

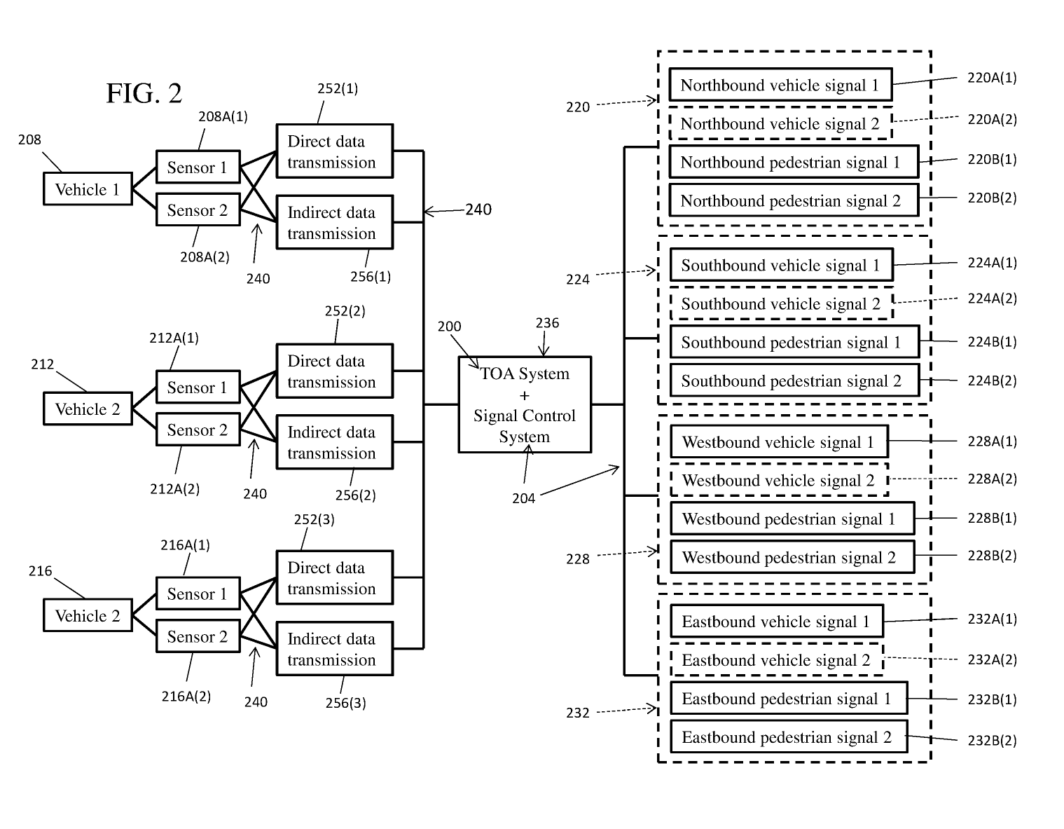

It is noted that a traffic-object-awareness system of the present disclosure, such as traffic-object-awareness system 104 of FIG. 1A, and also the software and/or software module(s) (i.e., machine-executable instructions 104E) therefor that provides awareness and call signal functionality described above, can reside at any suitable location. For example and as seen in FIG. 1A, traffic-object-awareness system 104 may be located at subject intersection 108. This may be the case, for example, when the subject intersection has a local signal controller 112A (see also, signal controller 236 of FIGS. 2-11). If signal controller 112A is located in a controller box (not shown) at intersection 108, traffic-object-awareness system 104 can be located in the same controller box or in another controller box located nearby and in communication with the signal controller in either a wired or wireless manner. In this case, communication system 104A of traffic-object-awareness system 104 may be located in the signal controller box or the traffic-object-awareness system box, as the case may be.

As another example, traffic-object-awareness system 104 may be located in sensor-equipped vehicles 124(1) to 124(N) themselves. For example, two or more sensor-equipped vehicles 124(1) to 124(N) of one vehicle manufacturer at intersection 108 suitably outfitted may communicate their respective location coordinates of objects, including ones of traffic objects 120(1) to 120(N) proximate to intersection 108 (i.e., object-location data) to each other using, for example, any one or more of the methods disclosed herein. By corresponding ones of sensor-equipped vehicles 124(1) to 124(N) combining the collective object-location data and processing the combined data set as disclosed herein to determine best, or most likely, location of one or more traffic objects 120(1) to 120(N) (e.g., pedestrians, bicycles, or other objects) (i.e., best-location data), and then communicating this outcome to each other through various means (e.g. wirelessly), each sensor-equipped vehicle will obtain a more accurate determination of where traffic objects exist. It can be expected that this will improve the safety and operation of sensor-equipped vehicles 124(1) to 124(N), whether traditionally driven or autonomous, etc. Competing vehicle manufacturers may choose to share this information with each other to improve overall roadway safety and, for example, to reduce the risk of their vehicles striking a pedestrian or bicyclist, among other types of traffic objects 120(1) to 120(N).

As another example, traffic-object-awareness system 104 may be located remotely from subject intersection 108. This may be the case, for example, when a single signal controller 112A controls multiple intersections (not shown), and the signal controller is located remotely from at least one of the intersections. It may also be the case, for example, that such signal control is effected from a single location (e.g. a city transportation office) for an entire transportation network. These systems are sometimes referred to as “Central Systems.” If subject intersection 108 is an intersection remote from signal controller 112A, traffic-object-awareness system 104 may be located at the signal controller and, therefore, remotely from the subject intersection. However, a receiver (not shown) of communications system 104A for traffic-object-awareness system 104 will typically be located at subject intersection 108 and may be in communication with the traffic-object-awareness system in a wired or wireless manner. Those skilled in the art will understand that these scenarios are illustrative and not exhaustive, since a traffic-object-awareness system of the present disclosure, such as traffic-object-awareness system 104 of FIG. 1A, can be located at any location where it can provide the requisite functionality.

In this example and referring still to FIG. 1A, each processor 128B(1) to 128B(N) and 104C may be, for example, any suitable type processor, such as a microprocessor, an application specific integrated circuit, part of a system on a chip, or a field-programmable gate array, among other architectures. Each processor 128B(1) to 128B(N) and 104C is configured to execute suitable machine-executable instructions 128D(1) to 128D(N) and 104E for controlling sensor systems 128(1) to 128(N) and traffic-object-awareness system 104 and any other functionalities of these systems. Each memory 128C(1) to 128C(N) and 104D may be any type(s) of suitable machine memory, such as cache, RAM, ROM, PROM, EPROM, and/or EEPROM, among others. Machine memory can also be another type of machine memory, such as a static or removable storage disk, static or removable solid-state memory, and/or any other type of persistent hardware-based memory. Fundamentally, there is no limitation on the type(s) of memory other than it be embodied in hardware. Machine-executable instructions 128D(1) to 128D(N) and 104E compose the software (e.g., firmware) of the corresponding respective sensor system 128(1) to 128(N) and traffic-object-awareness system 104.

Scenario 100 of FIG. 1A may also include one or more transgression response systems (collectively represented as transgression response system 132) that are engaged to elicit responses to transgressions detected by one or more of sensored-equipped vehicles 124(1) to 124(N). In this context, a transgression is an event, such as a traffic-object accident (e.g., a vehicle-to-fixed-object collision), a traffic-object-to-traffic-object collision (e.g., a vehicle-to-vehicle collision, vehicle-to-pedestrian collision, etc.), or other event that requires the dispatch and aid of one or more transgression responders (not shown), such as police, emergency medical technicians, and/or fire and rescue personnel, among others. In this example, traffic-object-awareness system 104 may include, for example, image analysis, detection, and classification algorithms, prioritization algorithms, and/or any other algorithm(s) need to provide the requisite functionality of determining whether or not to give any one or more detected traffic objects priority, encoded in machine-executable instructions 104E that have been configured and/or trained to detect sensor-based indicia of one or more types of transgressions in sensor data acquired by one or more sensor-equipped vehicles. Generally, the algorithms needed to make a traffic-object-state decision are referred to herein and in the appended claims as “traffic-object-state algorithms,” as these algorithms need to analyze the state of intersection 108 in terms of traffic objects 120(1) to 120(N). Such analysis can include determining locations and classifications of traffic objects, classifying transgressions, as well as determining facing directions and/or directions of travel (or velocity), among other things. Also and generally, each algorithm needed to determine whether any one or more of traffic objects 120(1) to 120(N) should be given priority are referred to herein and in the pending claims as a “prioritization algorithm.”

Upon traffic-object-awareness system 104 detecting and classifying the type of transgression, it may generate one or more transgression-response-request signals 132A and cause communications system 104A to send the transgression-response-request signal(s) to transgression response system 132. When transgression response system 132 receives transgression-response-request signal(s) 132A, it alerts the appropriate transgression responder(s) using any suitable alert system (not shown). It is noted that the image analysis, detection, and classification algorithms do not need to be located and executed at traffic-object-awareness system 104. For example, they may be located and executed aboard sensor-equipped vehicles 124(1) to 124(N), with the resulting transgression-response-request signal(s) 132A being relayed by traffic-object-awareness system 104 to transgression response system 132, with or without transformation. Those skilled in the art will understand how sensor-data analysis, detection, and classification algorithms may be implemented using various artificial intelligence tools. In addition, those skilled in the art will readily appreciate how to implement transgression-responder alert systems suitable for the type of transgression responders at issue.

As alluded to above, communications from or between sensor-equipped vehicles 124(1) to 124(N) to traffic-object-awareness system 104 may be direct (e.g., via V2I communications) as illustrated by wireless connection 136 or via a network 140 as illustrated by wireless connections 144 and 148 and optional wired connection 152. As those skilled in the art will readily appreciate, network 140, if present, may be composed of any one or more suitable networks, such as local area networks, wide area networks, global network (e.g., Internet), cellular networks, etc. Fundamentally, there is not limitation on the composition of network as long as the requisite functionality of traffic-object-awareness system 104 is achieved. It is also noted that while traffic-object-awareness system 104 is not shown as being connected through network 140, in can be, including when it is located aboard a sensor-equipped vehicle (not shown).

FIG. 1B illustrates an example method 160 of controlling a signalized traffic intersection, such as intersection 108 of FIG. 1A, controlled by a traffic signal controller, such as signal controller 112A of FIG. 1A. Referring primarily to FIG. 1B, but also to FIG. 1A for examples of components and elements that can be used with method 160, the method may begin at block 165 at which object-location information is continually obtained. The object-location information may be, for example, obtained by a traffic-object-awareness system, such as traffic-object-awareness system 104, based on sensor data from sensors located onboard one or more sensor-equipped vehicles, such as any one or more of sensor-equipped vehicles 124(1) to 124(N) located in proximity to intersection 108. The object-location location information may contain information locating one or more traffic objects at or proximate to the signalized traffic intersection. The process at block 165 may be performed in any one or more of a variety of ways, depending, for example, on the type of data the traffic-object-awareness system receives from the one or more sensor-equipped vehicles.

For example and as noted above, in some cases all processing of raw sensor data may occur aboard one or more of the sensor-equipped vehicles. In this case, the obtaining of object-location information at block 165 may include receiving the object-location information from the one or more sensor-equipped vehicles. In addition, the data coming from the one or more sensor-equipped vehicles may include an object classification for each traffic object detected, as well as data indicating which direction any particular traffic object is facing and/or a direction (or velocity) in which any particular traffic object is travelling. As another example, one or more sensor-equipped vehicles may not provide raw sensor data to the traffic-object-awareness system, in which case the traffic-object-awareness system itself may process the raw sensor data to obtain the object-location information. The traffic-object-awareness system may also process the raw sensor data to determine object classification, facing direction, and/or direction (or velocity) in which any particular traffic object is travelling. These two examples are generally at the extremes of the character of the data that the traffic-object-awareness system can receive from the one or more sensor-equipped vehicles. However, many other combination and permutations can exist, such as when differing sensor-equipped vehicles provide data of a variety of characters and completeness. Those skilled in the art will readily understand how to implement the process at block 165 depending on the data that the traffic-object-awareness system receives from the sensor-equipped vehicle(s) at any given time.

At block 170, one or more traffic-object-state algorithms, which use the object-location information for each of the one or more traffic objects and an object classification for each of the one or more traffic objects, are executed to determine a current state of at least one of the one or more traffic objects. The traffic-object-state algorithm(s) may be executed by a traffic-object-awareness system, such as traffic-object-awareness system 104 of FIG. 1A. Generally, to determine whether a priority call should be made, the traffic-object-awareness system needs to know the type(s), i.e., classification(s), of traffic object(s) and their locations and, in some scenarios, the direction any particular object is facing and/or moving, and the traffic-object-state algorithm(s) provide this knowledge. Because of the variability in the states that any given intersection can be in, in terms of traffic objects, it is impractical to provide exhaustive examples of traffic-object-state algorithms. However, those skilled in the art will readily understand how to configure such algorithm(s) for the intersection at issue.

At block 175, a travel-prioritization algorithm is executed to determine whether to give at least one of the one or more traffic objects travel priority. The travel-prioritization algorithm may be executed by a traffic-object-awareness system, such as traffic-object-awareness system 104 of FIG. 1A. Inputs to a travel-prioritization algorithm typically includes data about the state of each of one or more of the detected traffic objects. For example, if a detected traffic object is a pedestrian that the traffic-object-state has determined to be standing on a corner of an intersection, facing a crosswalk, and to have been there for a certain amount of time, a suitable travel-prioritization algorithm may be configured to use this data to determine that this pedestrian should get travel priority. Depending on a variety of factors, including the types of traffic objects desired to get travel priority and types of traffic signals present, the traffic-object-awareness system may include a number of differing travel-prioritization algorithms. For example, for an intersection where it is desired to give pedestrians and bicycles travel priority in certain instances, traffic-object-awareness system may have one travel-priority algorithm for the pedestrians and one travel-priority algorithm for the bicycles. That said, there may be a single comprehensive algorithm or there may be more than one algorithm per class of traffic object. As an example of the latter, there may be one travel-priority algorithm for pedestrians desiring to cross at a crosswalk an another travel-priority algorithm for jaywalkers. Fundamentally, there is no constraint on the how the travel-priority algorithm(s) is/are configured.

At block 180, when the travel prioritization algorithm has determined that travel priority should be given to at least one of the one or more traffic objects, a call signal is generated. The call signal is configured to cause the traffic signal controller to control the plurality of traffic signals to give the travel priority to the at least one of the one or more traffic objects. Examples of call signals are described below in the pedestrian and bicycle examples of FIGS. 2-11. At block 185, the call signal is transmitted to the traffic signal controller.

While example method 160 of FIG. 1B is described largely in the context of scenario 100 of FIG. 1A, it is noted that the method may be performed in a scenario different from scenario 100, including with elements that differ from the elements of scenario 100. If so, those skilled in the art will understand that modifications needed to adjust method 160 to utilize the elements available.

Bicycle/Pedestrian Examples

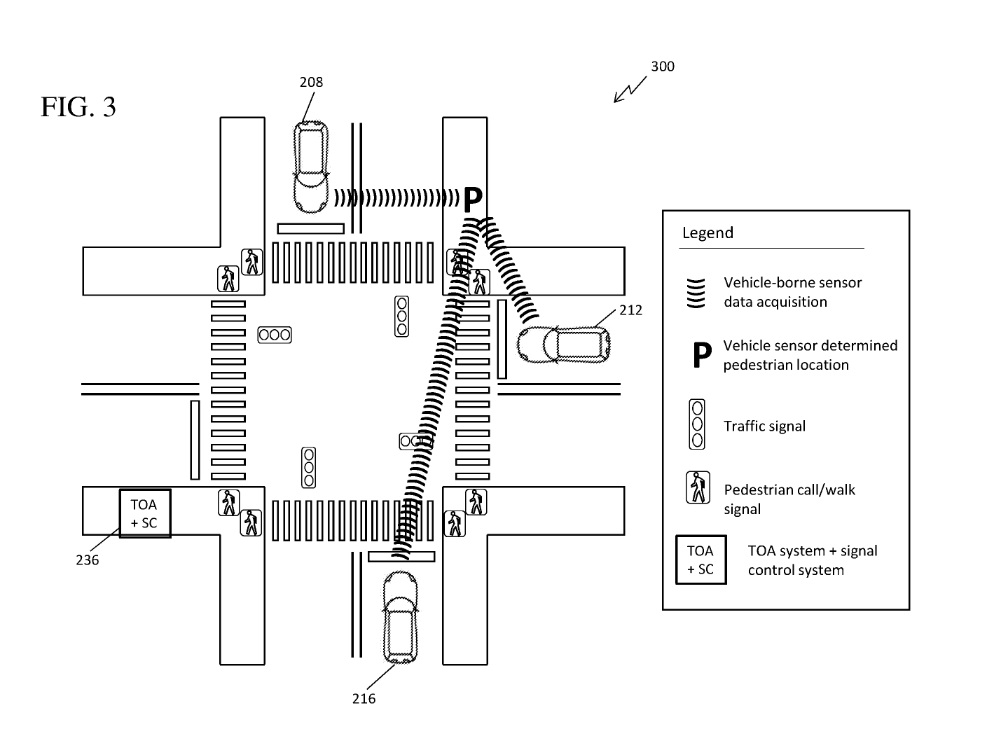

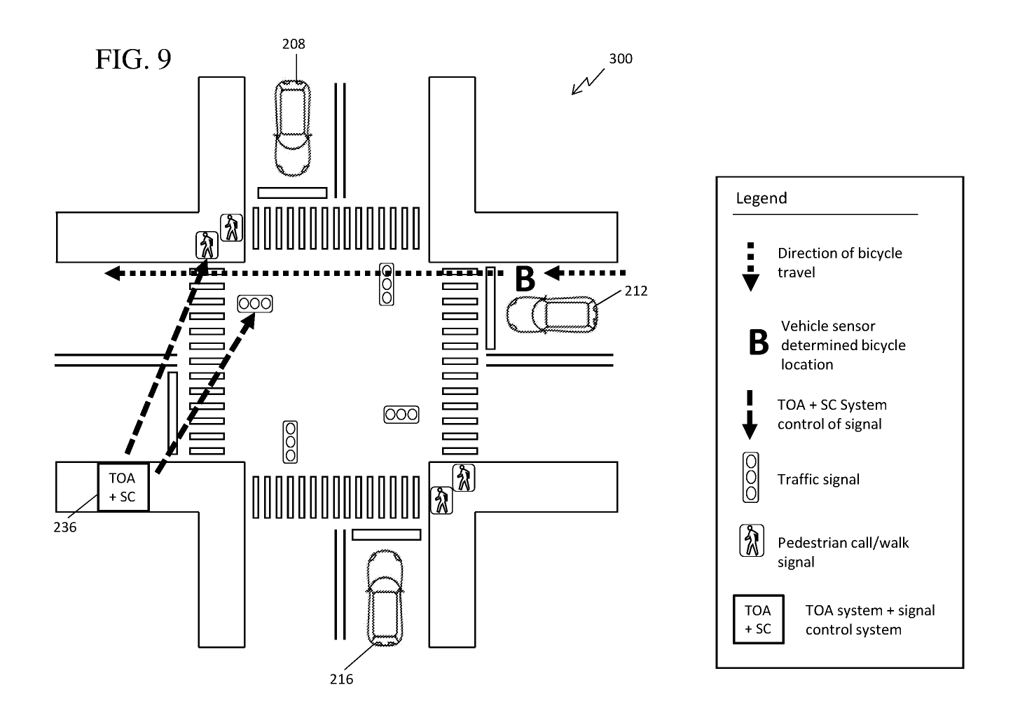

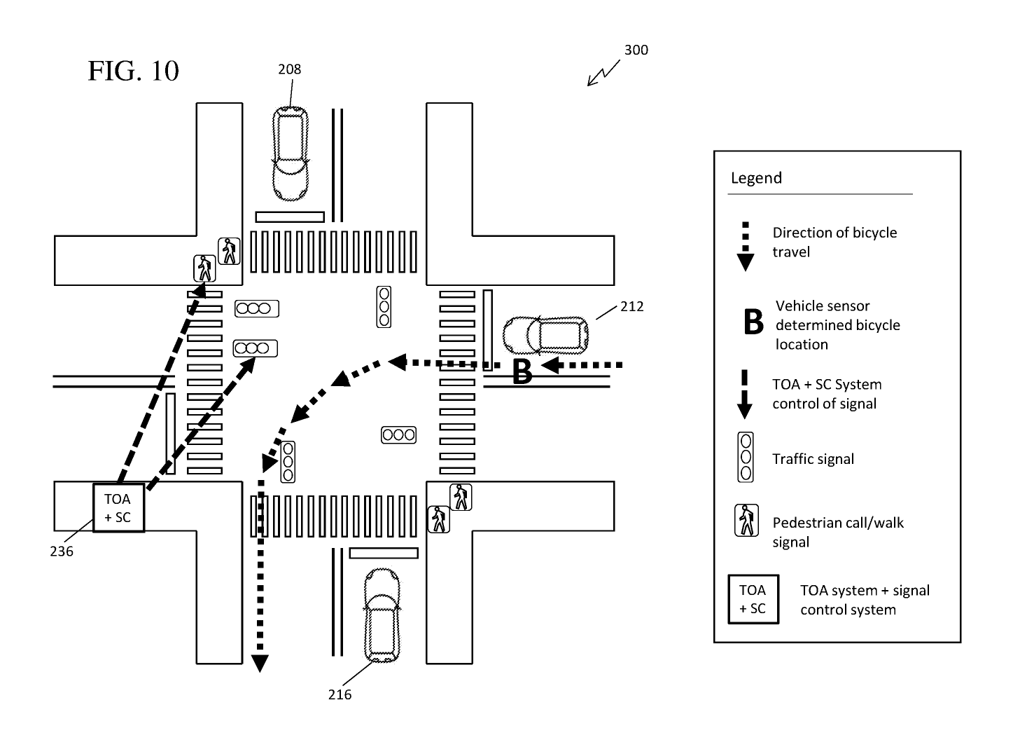

FIG. 2 illustrates various features of the example scenarios depicted in FIGS. 3 to 11. As described below in detail, these scenarios center on an example traffic-object-awareness system 200 that is adapted for improving traffic flow for pedestrians and bicycles within or proximate to a four-way intersection 300 (FIGS. 3 to 11) that includes conventional traffic-control infrastructure 204. It is noted that while these example scenarios are directed to pedestrians and bicycles, those skilled in the art will readily understand that principles described relative to these scenarios can be applied to other types of traffic objects as desired and as needed to suit a particular application. Similarly, while these example scenarios are based on four-way intersection 300 having conventional traffic-control infrastructure 204, those skilled in the art will understand how to adapt principles disclosed in these example scenarios to intersections of differing types and having differing traffic control infrastructure. In the example scenarios of FIGS. 3 to 11, pedestrians P (FIGS. 3-8 and 11) and bicycles B (FIGS. 9 and 10) are the traffic objects of interest; i.e., pedestrians P and bicycles B are the traffic objects that are the subjects of detection and locating by vehicle-borne sensors. For the sake of illustration, FIG. 2 shows three sensor-equipped vehicles 208, 212, 216, each equipped with two sensors 208A(1), 208A(2), 212A(1), 212A(2), 216A(1), 216A(2) (FIG. 2). In this example, traffic-object-awareness system 200 is designed and configured to use data from vehicle-borne sensors 208A(1), 208A(2), 212A(1), 212A(2), 216A(1), 216A(2) to determine, in real-time, whether or not the normal, or preprogramed, operation of traffic-control infrastructure 204 should be interrupted to provide a different (e.g., more effective) control scheme for intersection 300 (FIGS. 3-11).

Sensor-equipped vehicles 208, 212, and 216 (FIG. 2) may be any type of vehicle that can be outfitted with corresponding respective sensors 208A(1), 208A(2), 212A(1), 212A(2), 216A(1), 216A(2), such as a car, truck, bus, van, etc. Each sensor 08A(1), 208A(2), 212A(1), 212A(2), 216A(1), 216A(2) may be of any suitable type, such as any of the types noted above relative to sensors 128A(1) to 128A(N), among others. As noted above, the type(s) of sensors 208A(1), 208A(2), 212A(1), 212A(2), 216A(1), 216A(2) is/are not critical, as long as they provide data useful to the functioning of traffic-object-awareness system 200. It is noted that three sensor-equipped vehicles 208, 212, and 216 are illustrated for convenience. At any particular time, more or fewer than three sensor-equipped vehicles may be in communication with traffic-object-awareness system 200 and providing useful data thereto. It is also noted that each sensor-equipped vehicle 208, 212, 216 may have more or fewer than two sensors each.

Referring to FIG. 3, intersection 300 of these example scenarios includes one northbound vehicle lane 304N, one southbound vehicle lane 304S, one eastbound vehicle lane 304E, one westbound vehicle lane 304W, and four pedestrian crosswalks 308(1) to 308(4) perpendicular to the corresponding respective travel lanes. Also in these example scenarios and referring to FIG. 2, traffic-control infrastructure 204 includes a northbound movement signal set 220, a southbound movement signal set 224, a westbound movement signal set 228, and an eastbound movement signal set 232. Referring to FIGS. 2 and 3, each of these directional movement signal sets 220, 224, 228, and 232 includes a vehicle lane signal 220A(1), 224A(1), 228A(1), and 232A(1) and two pedestrian signals 220B(1) and 220B(2), 224B(1) and 224B(2), 228B(1) and 228B(2), and 232B(1) and 232B(2) (i.e., one for each side of a corresponding roadway). For redundancy, each signal set 220, 224, 228, and 232 may optionally include a second vehicle lane signal 220A(2), 224A(2), 228A(2), and 232A(2). Alternatively, if provided, second vehicle lane signals 220A(2), 224A(2), 228A(2), and 232A(2) may be used when each direction includes a second vehicle travel lane and/or turn lane. Directional movement signal sets 220, 224, 228, and 232 illustrated are only examples, and those skilled in the art will understand that other intersections may have other compositions of signal sets.

Still referring to FIGS. 2 and 3, traffic-control infrastructure 204 also includes a signal controller 236 for controlling vehicle lane signals 220A(1), 224A(1), 228A(1), and 232A(1) and, if present, 220A(2), 224A(2), 228A(2), and 232A(1), as well as pedestrian signals 220B(1) and 220B(2), 224B(1) and 224B(2), 228B(1) and 228B(2), and 232B(1) and 232B(2). Signal controller 236 in these example scenarios is preprogrammed in a conventional manner to provide conventional signal cycles to directional movement signal sets 220, 224, 228, and 232, for example, according to standard signal-cycle-programming practices for intersections of the type of intersection 300 and handling the traffic volume of intersection 300. Those skilled in the art will readily understand how signal controller 236 can be conventionally configured and programmed to suit the physical characteristics and traffic parameters of intersection 300.

In this example, signal controller 236 is integrated with traffic-object-awareness (TOA) system 204, which may be the same as or similar to traffic-object-awareness system 104 of FIG. 1. Signal controller 236 may comprise any suitable signal controller, such as a conventional signal controller, as long as it is configured to be responsive to call signals from traffic-object-awareness system 204. In this context, a call signal (not shown) from traffic-object-awareness system 204 to signal controller 236 is a signal that traffic-object-awareness system 204 generates when the traffic-object-awareness system determines an exception to the preprogrammed signal control scheme is needed or desirable, for example, to optimize the flow of traffic objects through or across intersection 300 and/or to increase the safety of traffic objects in or proximate to the intersection. A call signal from traffic-object-awareness system 204 may be configured in any manner compatible with signal controller 236. For example, signal controller 236 may be configured to be responsive to a call signal that includes one or more travel-lane-priority identifiers that identifies which travel lane(s) or travel directions require priority, along with priority-time value(s) that specify(ies) how long the identified travel lane(s) requires priority. It is noted that the priority-time value(s) need not be present if signal controller 236 is to use its own preprogrammed priority-time value(s). As another example, signal controller 236 may be configured to be responsive to a call signal that includes crosswalk priority identifier, along with a priority-time value that specifies how long the identified crosswalks require priority.

The example of FIG. 2 illustrates traffic-object-awareness system 204 receiving data (indicated by lines 240) from sensors 208A(1), 208A(2), 212A(1), 212A(2), 216A(1), 216A(2) aboard three corresponding respective sensor-equipped vehicles 208, 212, and 216 located proximate to intersection 300 (FIG. 3). As noted above relative to FIG. 1A, data 240 may be any type of data suitable for the configuration of traffic-object-awareness system 204. If traffic-object-awareness system 204 is configured to process raw data from some or all of sensors 208A(1), 208A(2), 212A(1), 212A(2), 216A(1), 216A(2), then data 240 may be raw sensor data for such sensors. If traffic-object-awareness system 204 is configured to use preprocessed data processed by sensors 208A(1), 208A(2), 212A(1), 212A(2), 216A(1), 216A(2) or higher-level sensor systems (not shown) aboard sensor-equipped vehicles 208, 212, and 216, then data 240 may be such preprocessed data. Those skilled in the art will readily understand the nature and character of data 240, depending on how much involvement traffic-object-awareness system 204 will have in processing raw data from sensors 208A(1), 208A(2), 212A(1), 212A(2), 216A(1), 216A(2).

In this example, each sensor 208A(1), 208A(2), 212A(1), 212A(2), 216A(1), 216A(2), or more typically, a processor (not shown), such as a vehicle processor, aboard each sensor-equipped vehicle 208, 212, 216, communicates to traffic-object-awareness system 204 via either a direct data transmission link 252(1), 252(2), 252(3) or an indirect data transmission link 256(1), 256(2), 256(3). Each direct data transmission link 252(1), 252(2), 252(3) may be, for example, a DSRC link (such as a V2V-type link) or other type of communications link noted above relative to FIG. 1, and indirect data transmission link 256(1), 256(2), 256(3) may be, for example, a link comprising a cellular communications link in combination with Internet communications links, among others. In this example, the choice between transmitting on either direct data transmission link 252(1), 252(2), 252(3) or indirect data transmission link 256(1), 256(2), 256(3) may be made automatically, depending on the capabilities of traffic-object-awareness system 204 and/or a current availability of one link over the other, among other things. Use of direct data transmission link 252(1), 252(2), 252(3) may be desired due to the relative quickness of the data transmission.

With the general features of FIG. 2 in mind for the example scenarios of FIGS. 3-11, FIGS. 3-11 illustrate various scenarios in which traffic-object-awareness system 204 is deployed to regulate the travel of pedestrians P and bicycles B across or through intersection 300 in conjunction with the regulation of other traffic objects, such as cars, trucks, buses, and/or other vehicles traditionally present within the vehicle travel lanes of the intersection. As will become apparent from the descriptions of FIGS. 3-11, sensors 208A(1), 208A(2), 212A(1), 212A(2), 216A(1), 216A(2) (FIG. 2) aboard one or more of sensor-equipped vehicles 208, 212, 216 are used to sense and locate pedestrians P and bicycles B, and traffic-object-awareness system 204 is configured to use data based on such sensing and locating to determine whether or not it should generate and provide a call signal to signal controller 236 to initiate an exception to the preprogrammed operation of the signal controller. It is noted that while these scenarios focus on pedestrians P and bicycles B as the traffic objects for which traffic-object-awareness system 204 is deployed, other scenarios can include other traffic objects as desired or needed to suit a particular composition of traffic at the intersection under consideration. As described below in more detail, aspects of this disclosure include, among other things, traffic-object-state algorithms for determining best locations of traffic objects based on information from several different data sources (e.g., sensor-equipped vehicles), and traffic-object-state algorithms for using that information to predict “intentions” of each traffic object (e.g., bicycle B or pedestrian P) being sensed and under consideration, e.g., to predict the likelihood that one or more travel objects desire to cross intersection 300 and then place one or more automatic travel priority “calls” for such bicycle(s) and/or pedestrian(s).

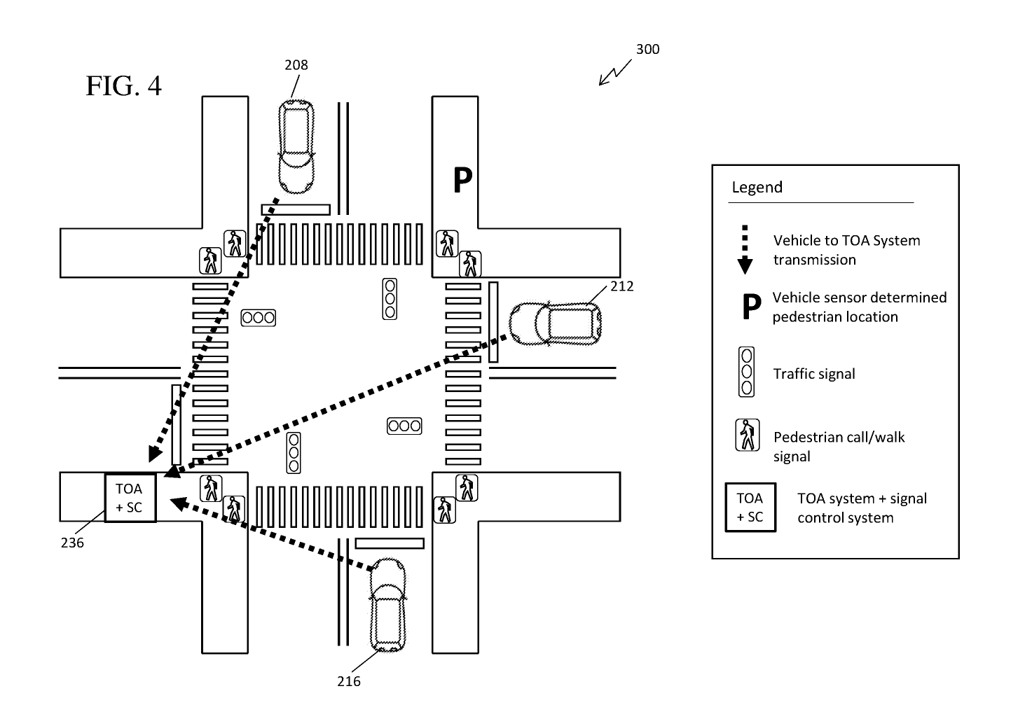

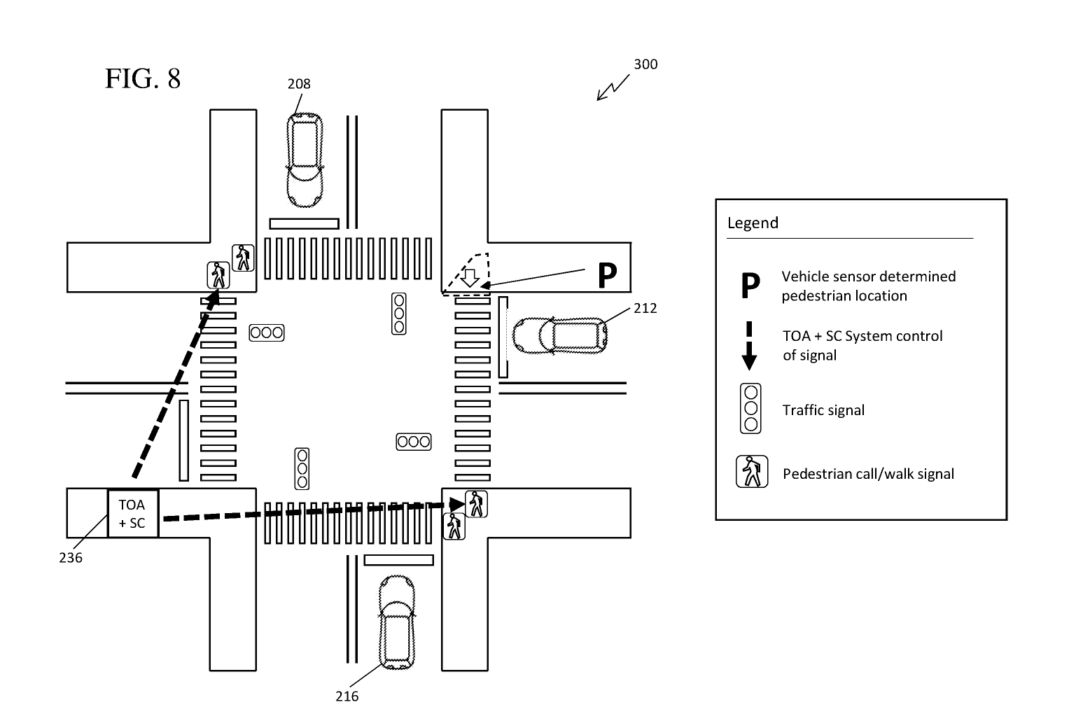

When viewing FIGS. 3-11, it should be kept in mind that not every action that takes place in a given scenario is illustrated in the corresponding figure. For example, and as described below in more detail, FIG. 8 depicts signal controller 236 as causing pedestrian signals 220B(1) and 224B(2) to change to their white (i.e., walk) phases in response to detection of a pedestrian P approaching corner 800 of intersection 300. Things not depicted in FIG. 8 for convenience, include the detection of pedestrian P by one or more sensors 208A(1), 208A(2), 212A(1), 212A(2), 216A(1), 216A(2) aboard each of sensor-equipped vehicles 208, 212, 216 (see, e.g., FIG. 3 for a similar depiction) and the transmission of sensor data 240 from the sensor-equipped vehicles to traffic-object-awareness system 204 (see, e.g., FIG. 4 for a similar depiction). In this connection, the reader's attention is directed to the legend of each of FIGS. 3-11 for further information about that figure. For example, as noted in the legend for FIG. 8, the solid “P” indicates the vehicle-sensor-determined pedestrian location, which implies that sensing of pedestrian P by sensor-equipped vehicles, such as sensor-equipped vehicles 208, 212, 216, has occurred and/or continues to occur. FIG. 8 depicts the control of pedestrian signals 220B(1) and 224B(2) by the combination of traffic-object-awareness system 204 and signal controller 236. Implied in this control are that 1) one or more sensor-equipped vehicles, such as sensor-equipped vehicles 208, 212, 216, have communicated sensor data 240 to traffic-object-awareness system 204, 2) the traffic-object-awareness system has used the sensor data to determine that a call signal to signal controller 236 is warranted, 3) the traffic-object-awareness system sent the call signal, and 4) the signal controller has responded to the call signal. Similar implications apply to aspects of each of FIGS. 9-11, as will be apparent from reviewing the corresponding respective legends.

Referring to FIGS. 3 and 4, and also to FIG. 2, in an example, sensor-equipped vehicles 208, 212, 216 equipped with sensors 208A(1), 208A(2), 212A(1), 212A(2), 216A(1), 216A(2) capable of detecting the locations of and identifying pedestrians P and bicycles B, as may be present at or proximate to intersection 300, may continuously and on a real-time basis determine the type and sense the location of such pedestrians and/or bicycles. The detecting and sensing of a single pedestrian P by at least one of the sensors 208A(1), 208A(2), 212A(1), 212A(2), 216A(1), 216A(2) aboard each of all three sensor-equipped vehicles 208, 212, 216 is depicted in FIG. 3. Correspondingly, as seen in FIG. 4, each sensor-equipped vehicle 208, 212, 216 transmits, for example continuously and on a real-time basis, data 240 containing the locations of all detected bicycles B (here, none) and pedestrians P (here, one) to traffic-object-awareness system 204. Traffic-object-awareness system 204 will collect data 240 from all such connected and sensor-equipped vehicles, here, sensor-equipped vehicles 208, 212, 216, such that the location and movement of one or more pedestrians P and/or bicycles B may be reported continuously by multiple sensor-equipped vehicles in proximity to single intersection 300.

In the context of some examples of a traffic-object-awareness system of the present disclosure, such as traffic-object-awareness system 204 of FIG. 2, “continuous reporting” means data transmission with enough frequency (e.g., every 1/10 of a second, every second, every 3 seconds, etc.) for the traffic-object-awareness system to track direction of travel of each traffic object while minimizing errors. As a negative example, a sensor that only supplies object-location information every 60 seconds for a pedestrian may be worthless to a traffic-object-awareness system of the present disclosure, since a pedestrian is highly likely to change speed and direction frequently within those 60 seconds, rendering the location data useless. On the other hand, if the location of the pedestrian is updated and transmitted every second or even more frequently, the information will typically be highly relevant, as changes in location and direction will be quickly captured.

The data collected by traffic-object-awareness system 204 may be in any one or more of a variety of forms, such as GPS coordinates, proximity distance data, direction data, raw video data, or any other form from the corresponding sensing vehicle, for example, any one of sensor-equipped vehicles 208, 212, 216 in FIG. 4. For example, traffic-object-awareness system 204 may collect the detailed latitude and longitude of pedestrian P as determined by several nearby sensor-equipped vehicles, here, sensor-equipped vehicles 208, 212, 216. Camera-type sensors may determine this information by comparing distances between known, fixed objects in the environment, such as light standards, buildings, mailboxes, etc., to the pedestrian P or bicycle B, comparing that information to stored high definition maps, and then reporting the location. Radar based sensors may obtain this information by transmitting a radio signal pulse and detecting the echoes of that signal off of nearby objects. By measuring the time lapse between signal transmission and echoes, as well as the direction of the reflected echo, radar systems determine distance and location of objects. LIDAR-based sensors may determine location in a similar fashion, using transmitted light rather than radio waves. As an example, traffic-object-awareness system 204 may collect the distance and relative direction of a traffic object from a nearby sensor-equipped vehicle (e.g. object distance 13.2 meters, bearing 315.23 degrees True North from a stopped vehicle located at latitude 33.24787634, longitude −117.69653323).

Traffic-object-awareness system 204 may collect the specific location data of each sensing vehicle 208, 212, 216 for comparative analysis. By comparing the location of objects, i.e., both traffic objects and non-traffic objects, relative to the bearing and location of a sensor-equipped vehicle, traffic-object-awareness system can determine true locations of objects. This can be enhanced by traffic-object-awareness system 204 further comparing to high definition maps of the local environment, or by comparing again to the known location of fixed objects (e.g., a traffic signal mast or sign, among other things).

As noted above, the data collected by traffic-object-awareness system 204 may also include object type if already determined by the sensor-equipped vehicle. Traffic-object-awareness system 204 may then process the overall received data (method described below) to determine a best location and if available, velocity for each bicycle B and/or pedestrian P detected. It is expected that each sensor-equipped vehicle, here sensor-equipped vehicles 208, 212, 216, will most likely provide a slightly different location and velocity for each bicycle B and/or pedestrian P due to natural variations, technology variations, equipment variations, and error inherent in the locating methodologies. Embodiments illustrated below describe various methods of determining a single best location from multiple data sources transmitting different locations for the same object.

In some embodiments, each sensor-equipped vehicle 208, 212, 216 delivers its data 240 to traffic-object-awareness system 204. Data 240 for stationary objects identified as normal roadway features (e.g., fire hydrants, trees, signs, traffic signal cabinets, etc.) or motor vehicles (i.e., not pedestrians or bicycles in this example) may be omitted if traffic-object-awareness system 204 will not use that data. This data may be previously known to traffic-object-awareness system 204 from high definition maps of the area, such as by being “learned” by the traffic-object-awareness system through repetitive awareness. For example, if sensor-equipped vehicles, such as sensor-equipped vehicles 208, 212, 216, throughout a day are reporting the location of an object in the same exact area repeatedly, traffic-object-awareness system 204 can reasonably infer that it is a stationary object and not a traffic object relevant for further analysis. When reported in the future by a sensor-equipped vehicle, traffic-object-awareness system 204 may be programmed to ignore it. As another example, if traffic-object-awareness system 204 determines an object to have the size and shape of a known object, such as a fire hydrant or road sign, it can also be reasonably determined to be irrelevant for further analysis and ignored. The remaining objects are considered likely pedestrians or bicycles.

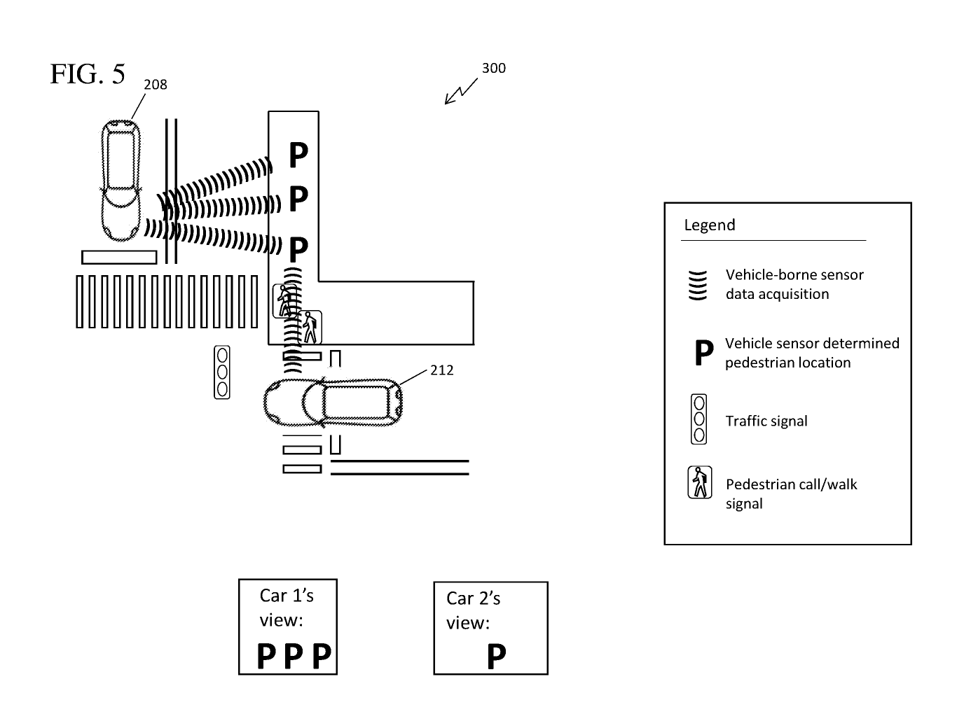

Due to possibility of a single sensor having limited ability in detecting individual objects in a group, especially where at least one of the objects is occluded by one or more other objects in the group, in some embodiments traffic-object-awareness system 204 may be programmed to combine sensor data (e.g., image a location data) from multiple sensor-equipped vehicles to create a three-dimensional rendering of the objects within a group. An example of this is illustrated in FIG. 5 for intersection 300. As seen in FIG. 4 sensor-equipped vehicle 208 facing south is detecting three pedestrians P walking south. Another sensor-equipped vehicle 212, facing west and situated so that a side sensor (not shown) is in line with pedestrians P, is detecting only the pedestrian P closest to sensor-equipped vehicle 212. However, by processing the combined information from both vehicles 208, 212, traffic-object-awareness system 204 develops a more accurate assessment of object location (e.g., “there are three pedestrians in-line walking south, with the first at latitude X and longitude Y, the second at latitude A and longitude B, and the third at latitude C and longitude D”). This type of processing can occur by sensor-equipped vehicles 208, 212 combining and processing the data (and subsequently delivering the processed data 240 to traffic-object-awareness system 204), or by traffic-object-awareness system 204 itself.

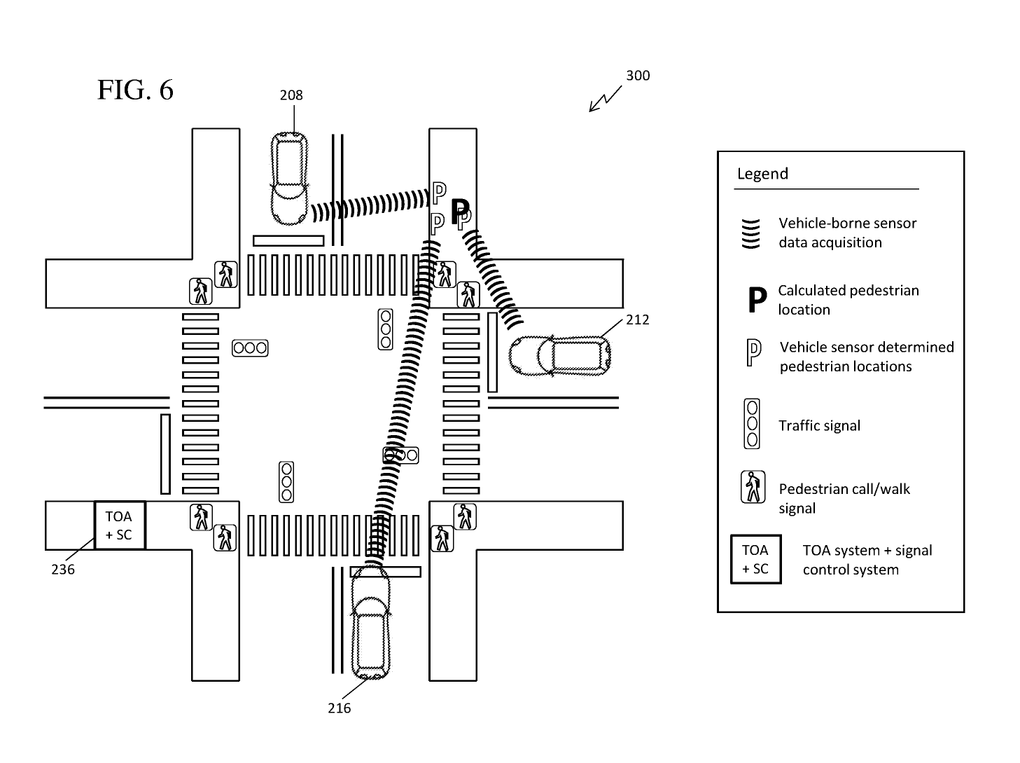

FIG. 6 illustrates a scenario in which at least one sensor 208A(1), 208A(2), 212A(1), 212A(2), 216A(1), 216A(2) aboard each of sensor-equipped vehicles 208, 212, 216 is detecting a pedestrian P heading south. Location data is determined to refer to a specific object based initially on proximity and quantity. For example, if three separate sensor-equipped vehicles 208, 212, 216 count one pedestrian P as illustrated but provide three separate locations for that pedestrian within, say, one meter of one another, traffic-object-awareness system 204, or vehicles 208, 212, 216 themselves, may determine that those three locations represent the same pedestrian P. In this connection, it is noted that traffic-object-awareness system 204, or vehicles 208, 212, 216 themselves, may use a calculated location for the pedestrian P based on the three sensor-determined locations for that pedestrian.

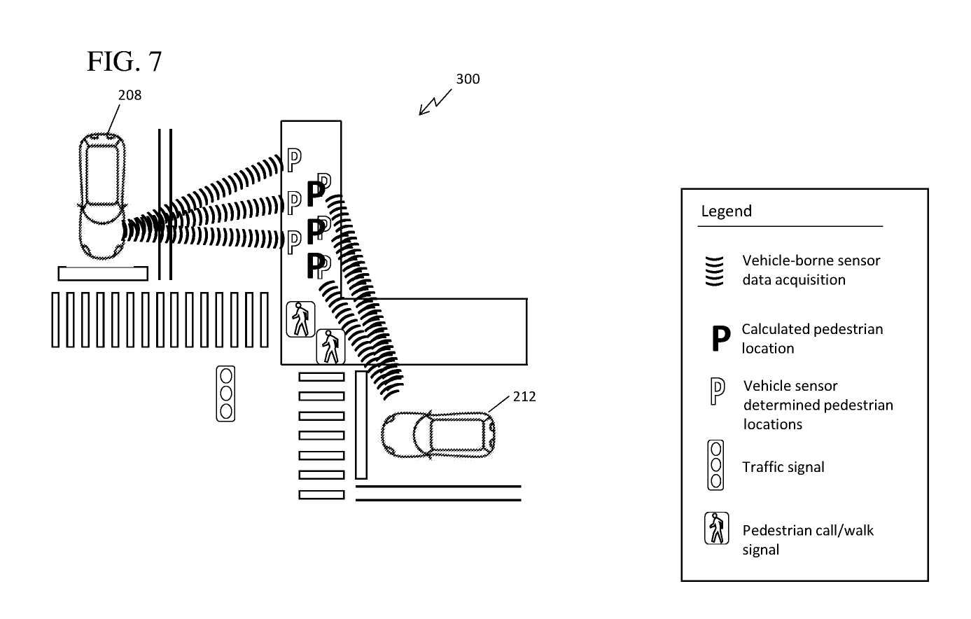

In another example and as illustrated in FIG. 7, if two separate sensor-equipped vehicles 208, 212 detect three pedestrians P moving from north to south, but six unique pedestrian locations are delivered to, or determined by, traffic-object-awareness system 204 (each sensor-equipped vehicle 208, 212 sends locations for all three pedestrians P, and they all differ), the vehicles or the traffic-object-awareness system may be programmed to consider the lead pedestrian P location provided by each sensor-equipped vehicle 208, 212 to be the same pedestrian, the second pedestrian location provided by each vehicle to be the second pedestrian, and so forth. As with the previous example, traffic-object-awareness system 204, or vehicles 208, 212, 216 themselves, may use a calculated location for each of the pedestrians P based on the two sensor-determined locations for each pedestrian.

There are a variety of ways to calculate a location of a pedestrian or bicycle using sensor data from two or more sensors. For example, upon determining which location inputs refer to the same object, the relevant location inputs may simply be averaged to provide a best location. As another example, the location inputs for a given object may be weighed based on the proximity of the reporting sensor to the detected bicycle or pedestrian, and the weighted average location may be used to provide a best location value. For example, the sensor data provided by a vehicle 5 meters from an object may be accorded twice the weight as sensor data provided by a vehicle 10 meters from an object. As yet another example, the location inputs from the differing sensors may be weighted based on known sensor accuracy and/or quality in use. For example, data obtained from a more reliable and/or accurate sensor will be weighted more strongly. The sensor type may be transmitted with the location data, or the vehicle type (make, model, vehicle identification number (VIN), or other identifiable marker) may be transmitted with the location data. The weighted average of the location inputs is then used to provide a best location value. For example, if a sensor aboard a first vehicle of a particular model from one vehicle manufacturer is known to provide twice the sensor accuracy as a sensor aboard a second vehicle of a differing model from a differing manufacturer, and the first vehicle provides a pedestrian location 3 meters from the location supplied by the second vehicle, the traffic-object-awareness system may provide a weighted average best location of the pedestrian one meter from the first vehicle and 2 meters from the second vehicle.

As a further example, the location inputs from differing sensors may be weighed based on the known latency of information transmission. For example, a direct transmission of location data will have less latency and be more useful than one requiring indirect routing through distant information technology hardware (e.g., corporate servers). A traffic-object-awareness system could be configured to determine the source of data based on how the data is received. For example, if received through a DSRC receiver, then the traffic-object-awareness system would know that the location data has been transmitted directly to it. If received through an internet-based application programming interface (API), then the traffic-object-awareness system would know that the location data has been transmitted indirectly to it. A traffic-object-awareness system can be programmed to test and update precise latency times regularly as methods and technology advances.

As yet a further example, a traffic-object-awareness system can utilize a combination of some or all of the above examples to determine the best location for each object detected and located by multiple vehicle-borne sensors. For example, if a sensor-equipped vehicle is known to use better sensor technology, is closer to the detected object, and has low latency data transmission, its location data will be weighted much more strongly that if it only had one of these beneficial features.

A traffic-object-awareness system of the present disclosure will typically update the weighted average location of bicycles and pedestrians on a continual, real-time basis by both the sensor-equipped vehicles and the traffic-object-awareness system. If a bearing and distance, or latitude and longitude are changing, the sensor-equipped vehicles and/or traffic-object-awareness system will compare those changes to amount of time elapsed to determine direction and velocity of travel of each bicycle or pedestrian. The traffic-object-awareness system can be programmed to use the direction and velocity of travel to reasonably determine the intent of the bicycle or pedestrian in crossing the intersection it is approaching.

As an example and as illustrated in FIG. 8, a pedestrian P is determined by traffic-object-awareness system 204 and/or vehicles 208, 212, 216 to be approaching intersection 300 from the east, as indicated by arrow 800. Traffic-object-awareness system 204 and/or vehicles 208, 212, 216 may determine this movement by analyzing the changes in rapidly updated location information for pedestrian P, a comparative analysis of which reveals a westerly movement. If the location of pedestrian P is observed to stop (the person is now standing) on the southern portion (as indicated by region 804) of the intersection corner 808 and/or oriented facing south (as indicated by arrow 812), traffic-object-awareness system 204 will automatically generate and provide a crosswalk call signal (not shown) to signal controller 236 to provide a southern pedestrian passage. This crosswalk call signal will cause, as needed, vehicle lane signals 220A(1) and 224A(1) to change to their green phases, vehicle lane signals 228A(1), and 232A(1) to change to their red phases, pedestrian signals 220B(1) and 220B(2), 224B(1) and 224B(2) to change to their white (walk) phases, and pedestrian signals 228B(1) and 228B(2), and 232B(1) and 232B(2) to change to their orange (don't walk) phases. To avoid clutter, pedestrian signals 224B(1), 228B(1), 220B(2), and 232B(2) are not shown in FIG. 8. Similar movement and orientation analyses can be performed for each corner of intersection 300 to determine whether or not traffic-object-awareness system 204 should make an automatic crosswalk call. More sophisticated algorithms can be used to consider other factors, such as number of pedestrians present, which ways they are proceeding and/or oriented, and vehicle queue lengths, among others, to provide more optimal control.

Traffic-object-awareness system 204 and/or sensor-equipped vehicles proximate intersection 300 can determine pedestrian orientation using any one or more of a number of methods. As one example, an image/camera based sensor system, capable of face detection and located south of a pedestrian P (such as aboard vehicle 216 (FIG. 8)), or traffic-object-awareness system 204 receiving data from such sensor system, may reasonably conclude that the face of the pedestrian is facing south and therefore intends to travel south. As another example, such an image/camera based sensor system located at least partially westward of a pedestrian (such as aboard vehicle 208) that does not detect a face on that same pedestrian P, may reasonably conclude that the face is facing a direction other than west. Since pedestrian P only has two potential directions of intersection passage, here west and south, traffic-object-awareness system 204 and/or vehicle 208 may reasonably assume pedestrian P is facing in the other direction and intends to cross in that direction.

As another example, pedestrian orientation can also be determined using radar or LIDAR-based systems. LIDAR-based systems having enough resolution may directly detect the topography of a face, and similar to the image/camera based example above, could determine the direction and intent of a pedestrian facing an intersection. In a further example, radar- or LIDAR-based systems may, based on the size and shape of the reflected image, detect if a pedestrian P is presenting its profile/side or front. Such system and/or traffic-object-awareness system 204 may use that information to determine intent of pedestrian P to cross intersection 300 in one direction or the other at any particular corner of the intersection. For example, if a LIDAR-based sensor system detects a 6-foot-tall object standing on a corner of intersection 300, but also detects that the object is only 1-foot wide, the sensor system and/or traffic-object-awareness system 204 may interpret this as a human profile and may assume pedestrian P is not facing the LIDAR-based sensor system, and therefore is going to cross in the other direction. However, if the LIDAR-based sensor system detects the same 6-foot-tall object (person) with a 2-foot width, the sensor system and/or traffic-object-awareness system 204 may conclude that a pedestrian P is facing the LIDAR-based sensor system and intends to cross in the direction towards the sensor system.

FIG. 9 illustrates an example scenario in which a bicycle B is traveling westward in approach to intersection 300. In this example, sensor-equipped vehicles 208, 212, 216, perhaps to different extents because of occlusion, detect and/or locate bicycle B and provide corresponding sensor data 240 to traffic-object-awareness system 204 (the transmission are not depicted in FIG. 9. Based on sensor data 240, traffic-object-awareness system 204 sends a call signal (not shown) to signal controller 236 that, to the extent needed, controls signal sets 220, 224, 228, 232 as needed to allow bicycle B to pass through intersection 300, continuing to travel westward. While FIG. 9 depicts signal controller 236 as controlling only northbound pedestrian signal 220B(1) (putting it into its orange (don't walk) phase) and westbound travel lane signal 228A(1) (putting it into its green phase) for simplicity, in actuality, the signal controller will typically control all of the vehicle lane signals 220A(1), 224A(1), 228A(1), and 232A(1) and, if present, 220A(2), 224A(2), 228A(2), and 232A(1), as well as pedestrian signals 220B(1) and 220B(2), 224B(1) and 224B(2), 228B(1) and 228B(2), and 232B(1) and 232B(2) to ensure safe functioning of intersection 300.

FIG. 10 illustrates a bicycle scenario similar to the scenario depicted in FIG. 9.

However, in this scenario, a bicycle B approaches intersection 300 heading westward on the left-hand, or southern side of westbound travel lane 304W. In this example, when bicycle B approaches intersection 300 from the east and stops on the southern side of westbound travel lane 304W as illustrated in FIG. 10, traffic-object-awareness system 204 and/or one or more of sensor-equipped vehicles 208, 212, 216 may interpret the intention of bicycle (bicyclist) B to turn south onto southbound travel lane 304S. Based on this interpretation, traffic-object-awareness system 204 may automatically generate a call signal and provide that call signal to signal controller 236, which, in turn, controls movement signal sets 220, 224, 228, and 232 in a manner that gives priority to bicycle B in a suitable manner. In this connection, if westbound movement signal set 228 includes the second vehicle lane signal 228A(2) having a left-hand-turn signal, part of the signal control scheme of signal controller 236 will include providing that left-hand-turn signal with its green turn-arrow phase. Alternatively, another control scheme giving priority to bicycle B can be used, such as making vehicle lane signal 228A(1) full green (without second vehicle lane signal 228A(2)) while putting all other vehicle lane signals 220A(l), 224A(1), 228A(1), 232A(1) into their red phases.

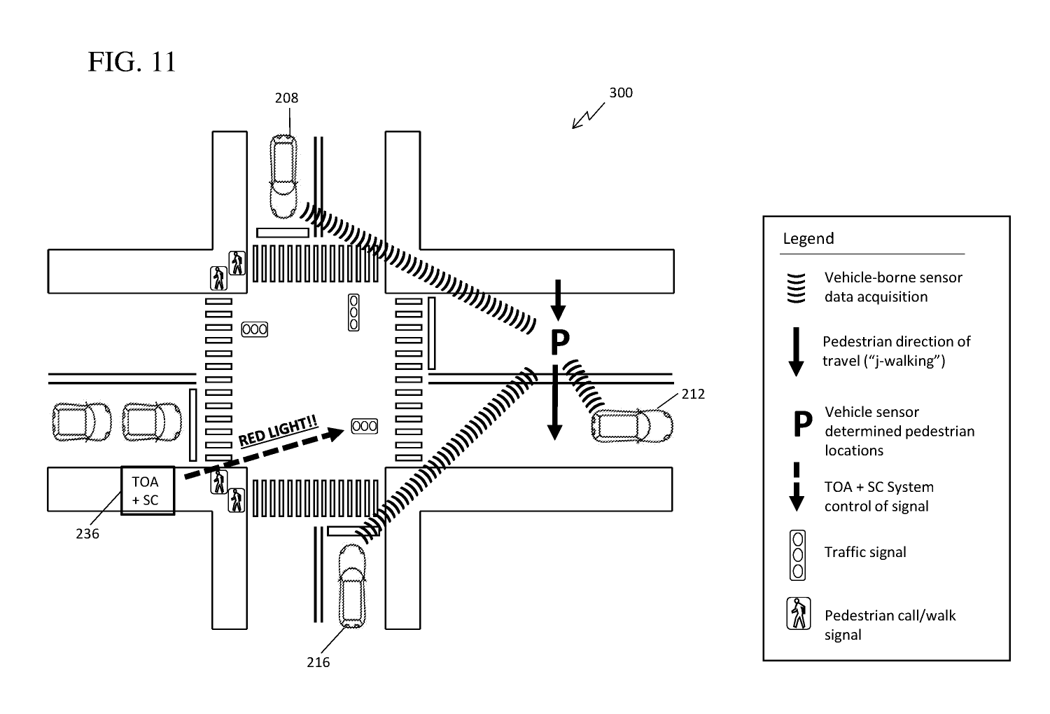

FIG. 11 illustrates an example scenario in which a pedestrian P is jaywalking, i.e., crossing a road at a location other than a designated crosswalk, namely, crosswalk 308(2) in this example. In this scenario, pedestrian P is detected and located by one or more sensors 208A(1), 208A(2), 212A(1), 212A(2), 216A(1), 216A(2) aboard each of sensor-equipped vehicles 208, 212, 216. Correspondingly, sensor-equipped vehicles 208, 212, 216 send (not illustrated) sensor data 240 (FIG. 2) to traffic-object-awareness system 204, which alone or in conjunction with the sensor-equipped vehicles determines that pedestrian P is jaywalking, generates a call signal (not shown) and sends it to signal controller 236 to control the relevant vehicle lane signal 220A(l), 224A(1), 228A(1), and 232A(1) and pedestrian signals 220B(1), 220B(2), 224B(1), 224B(2), 228B(1), 228B(2), 232B(1) and 232B(2) in a manner that provides the pedestrian as safe a passage across the remainder of the roadway as possible. For example, if eastbound travel lane signal 232A(1) is in its green phase when pedestrian P is determined to be jaywalking as shown, then in response to the call signal, signal controller 236 may cause the eastbound travel lane signal to change to its red phase. Of course, other signal control schemes can be used depending upon, for example, the signal states when it has been determined that pedestrian P is jaywalking or appears to have the intention of jaywalking.

Multi-Vehicle Collaboration

As noted above, in some embodiments sensor-equipped vehicles can collaborate with one another to perform a variety of functions, including determining a best location for each object of interest and/or, if used in conjunction with a traffic-object-awareness system that interacts with a signal controller that controls one or more roadway intersections, generating and transmitting call signal to the signal controller, among other things. It is noted that the inter-vehicle collaboration functionalities described in this section can be used for any suitable purpose(s), including purposes independent from controlling signalized roadway intersections. FIG. 12 illustrates an example scenario in which a plurality of sensor-equipped vehicles, here, five sensor-equipped vehicles 1200(1) to 1200(5), collaborate with one another to determine the best location for each object of interests that the sensor-equipped vehicles are substantially simultaneously detecting and locating. In this example, each of the five sensor-equipped vehicles 1200(1) to 1200(5) are detecting and locating two pedestrians P (objects of interest) that are walking alongside a roadway 1204 on which the sensor-equipped vehicles are traveling. As denoted by the legend accompanying FIG. 12, each sensor-equipped vehicle 1200(1) to 1200(5), via one or more sensors (not shown), acquires sensor data concerning the detection and location of each of the two pedestrians P and determines a type of the object(s) being detected (here, pedestrians), as well as a location for each of the objects (again, pedestrians). As seen in FIG. 12, the locations determined from a single sensor or single vehicle (outlined “P”) differ among sensor-equipped vehicles 1200(1) to 1200(5). However, in this scenario, the multiple sensor-equipped vehicles 1200(1) to 1200(5) share their individually determined object identification(s) and location(s) with one another, and one or more of the sensor-equipped vehicles determine a best location using a suitable scenario.

Sensor-equipped vehicles 1200(1) to 1200(5) may communicate with one another using any suitable V2V communications protocol, such as via a DSRC radio system (not shown). Each sensor-equipped vehicle 1200(1) to 1200(5) may, for example, broadcast the number, types, distances, bearings, and/or locations of identified and located objects for reception by any other sensor-equipped vehicles within receiving range. Each sensor-equipped vehicle 1200(1) to 1200(5) may also broadcast other information that may be useful to each receiving sensor-equipped vehicle within reception and/or sensing range, such as vehicle make and model and/or other vehicle identifier, type(s) and/or model(s) of sensor(s) used to acquire sensor data, figure(s) of merit for the sensor(s) used to acquire sensor data, and/or vehicle location and/or movement data, such as speed and heading, among other information that may be useful for collaboration among the multiple sensor-equipped vehicles 1200(1) to 1200(5).

In some embodiments, each sensor-equipped vehicle 1200(1) to 1200(5) may utilize the same algorithm(s) for determining the best location for each of the objects at issue. Consequently, when, say sensor-equipped vehicle 1200(2) receives identification and location data for the same object it has identified and located, when it uses its own and the others' identification and location data, the best location it determines for that object will be the same as the best location determined by sensor-equipped vehicle 1200(4) using the same data. As noted above, the best location can be calculated from a plurality of locations determined by individual vehicles or sensors using any one or more of a variety of methodologies, including the methodologies described above in conjunction with FIG. 7. A threshold analysis that may be performed is to determine whether or not the multiple vehicles are detecting and locating the same object(s) of interest.

In some embodiments, when two or more sensor-equipped vehicles, such as sensor-equipped vehicles 1200(1) to 1200(5), are detecting one or more of the same objects of interest, one of the sensor-equipped vehicles may be designated the “master” of the group, which will then take the lead in acquiring sensor data from the other sensor-equipped vehicle(s) and executing the algorithm(s) for determining the best location for each of the one or more objects of interest. The master sensor-equipped vehicle of the group may be determined in any of a variety of ways. For example, the master sensor-equipped vehicle may be determined to be the sensor-equipped vehicle that is both farthest from a nearest object of interest being detected and heading in a direction generally toward that object. These facts would often mean that that particular sensor-equipped vehicle will have the greatest period of time in proximity to at least one of the objects of interest before passing master control to another vehicle.

In some embodiments, each of one or more vehicle manufacturers may equip their sensor-equipped vehicles with the ability of collaborate with one another as described herein. Thus, such collaboration may occur only when two or more sensor-equipped vehicles from the same manufacturer are within collaboration distance of each other and are detecting one or more common objects of interest. In some cases, such equipping may be, for example, of only one or more specific models and/or trim levels of the manufacturer or all models and/or trim levels of that manufacturer. In some embodiments, two or more manufacturers may collaborate with one another and/or adhere to standards set by an authority, such as a federal government, to allow their sensor-equipped vehicles to collaborate with one another as described herein.

Example Computing System

It is to be noted that any one or more of the aspects and embodiments described herein may be conveniently implemented using one or more machines (e.g., one or more computing devices part of or otherwise associated with a traffic-object-awareness system of the present disclosure) programmed according to the teachings of the present specification, as will be apparent to those of ordinary skill in the pertinent art(s). Appropriate software code can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

The software for the pedestrian and/or bicycle awareness system and/or multivehicle collaboration may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

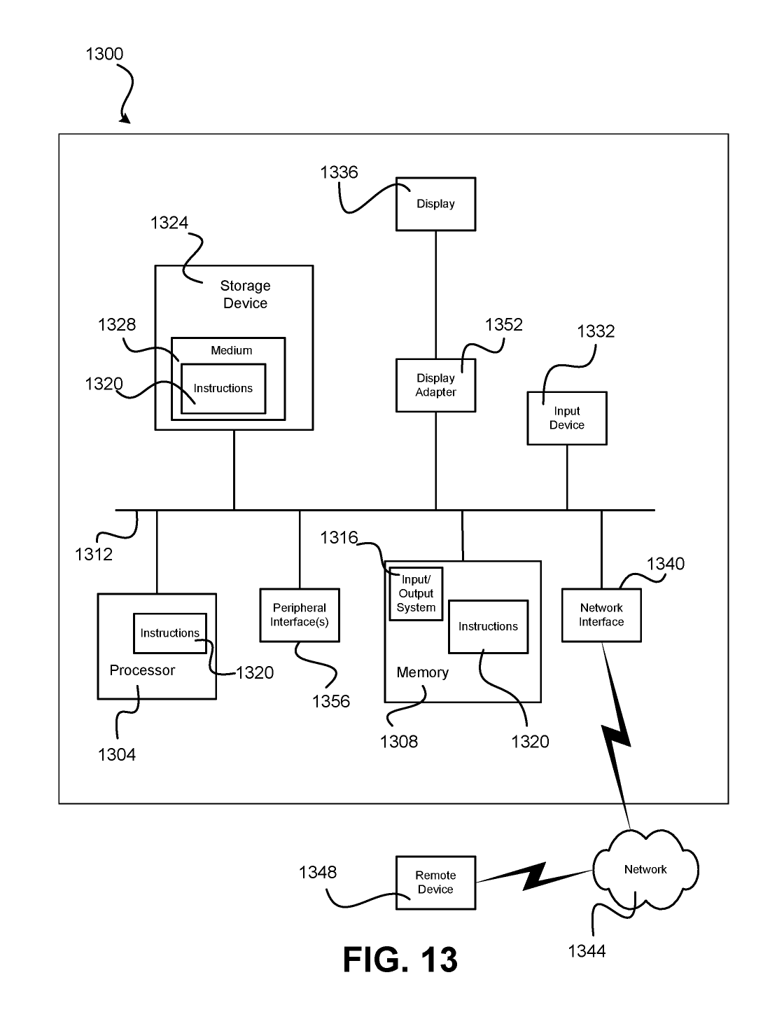

FIG. 13 shows a diagrammatic representation of one embodiment of a computing device in the exemplary form of a computer system 1300 within which a set of instructions for causing a control system, such as the X system of FIG. Y, to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1300 includes a processor 1304 and a memory 1308 that communicate with each other, and with other components, via a bus 1312. Bus 1312 may include any of several types of bus structures including, but not limited to, a memory bus, a memory controller, a peripheral bus, a local bus, and any combinations thereof, using any of a variety of bus architectures.

Memory 1308 may include various components (e.g., machine-readable media) including, but not limited to, a random access memory component, a read only component, and any combinations thereof. In one example, a basic input/output system 1316 (BIOS), including basic routines that help to transfer information between elements within computer system 1300, such as during start-up, may be stored in memory 1308. Memory 1308 may also include (e.g., stored on one or more machine-readable media) instructions (e.g., software) 1320 embodying any one or more of the aspects and/or methodologies of the present disclosure. In another example, memory 1308 may further include any number of program modules including, but not limited to, an operating system, one or more application programs, other program modules, program data, and any combinations thereof.

Computer system 1300 may also include a storage device 1324. Examples of a storage device (e.g., storage device 1324) include, but are not limited to, a hard disk drive, a magnetic disk drive, an optical disc drive in combination with an optical medium, a solid-state memory device, and any combinations thereof. Storage device 1324 may be connected to bus 1312 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1324 (or one or more components thereof) may be removably interfaced with computer system 1300 (e.g., via an external port connector (not shown)). Particularly, storage device 1324 and an associated machine-readable medium 1328 may provide nonvolatile and/or volatile storage of machine-readable instructions, data structures, program modules, and/or other data for computer system 1300. In one example, software 1320 may reside, completely or partially, within machine-readable medium 1328. In another example, software 1320 may reside, completely or partially, within processor 1304.

Computer system 1300 may also include an input device 1332. In one example, a user of computer system 1300 may enter commands and/or other information into computer system 1300 via input device 1332. Examples of an input device 1332 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1332 may be interfaced to bus 1312 via any of a variety of interfaces (not shown) including, but not limited to, a serial interface, a parallel interface, a game port, a USB interface, a FIREWIRE interface, a direct interface to bus 1312, and any combinations thereof. Input device 1332 may include a touch screen interface that may be a part of or separate from display 1336, discussed further below. Input device 1332 may be utilized as a user selection device for selecting one or more graphical representations in a graphical interface as described above.

A user may also input commands and/or other information to computer system 1300 via storage device 1324 (e.g., a removable disk drive, a flash drive, etc.) and/or network interface device 1340. A network interface device, such as network interface device 1340, may be utilized for connecting computer system 1300 to one or more of a variety of networks, such as network 1344, and one or more remote devices 1348 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1344, may employ a wired and/or a wireless mode of communication. In general, any network topology may be used. Information (e.g., data, software 1320, etc.) may be communicated to and/or from computer system 1300 via network interface device 1340.

Computer system 1300 may further include a video display adapter 1352 for communicating a displayable image to a display device, such as display device 1336. Examples of a display device include, but are not limited to, a liquid crystal display (LCD), a plasma display, a light emitting diode (LED) display, and any combinations thereof. Display adapter 1352 and display device 1336 may be utilized in combination with processor 1304 to provide graphical representations of aspects of the present disclosure. In addition to a display device, computer system 1300 may include one or more other peripheral output devices including, but not limited to, an audio speaker, a printer, and any combinations thereof. Such peripheral output devices may be connected to bus 1312 via a peripheral interface 1356. Examples of a peripheral interface include, but are not limited to, a serial port, a USB connection, a FIREWIRE connection, a parallel connection, and any combinations thereof.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of controlling a signalized traffic intersection based on presence of one or more traffic objects in proximity to the signalized traffic intersection, wherein the signalized traffic intersection includes a plurality of traffic signals controlled by a traffic signal controller, the method being executed by a traffic-object-awareness system and comprising:
continually obtaining object-location information based on sensor data from sensors located onboard one or more sensor-equipped vehicles in proximity to the signalized traffic intersection, wherein the object-location information contains information locating one or more traffic objects at or proximate to the signalized traffic intersection;
executing one or more traffic-object-state algorithms that use the object-location information for each of the one or more traffic objects and an object classification for each of the one or more traffic objects to determine a current state of at least one of the one or more traffic objects;
executing a travel-prioritization algorithm to determine whether to give at least one of the one or more traffic objects travel priority;
when the travel-prioritization algorithm has determined that travel priority should be given to at least one of the one or more traffic objects, generating a call signal configured to cause the traffic signal controller to control the plurality of traffic signals to give the travel priority to the at least one of the one or more traffic objects; and
transmitting the call signal to the traffic signal controller.

2. The method according to claim 1, wherein continually collecting object-location information includes receiving at least some of the object-location information directly from a sensor-equipped vehicle via vehicle-to-infrastructure wireless communication.

3. The method according to claim 1, wherein continually collecting object-location information includes receiving at least some of the object-location information indirectly via Internet protocol communications.

4. The method according to claim 1, further comprising determining a most-likely location of the at least one of the one or more traffic objects using object-location information from multiple sensor-equipped vehicles.

5. The method according to claim 4, further comprising assigning weights to object-location information from the multiple sensor-equipped vehicles based on mode of communication between the multiple sensor-equipped vehicles and the traffic-object-awareness system.

6. The method according to claim 4, further comprising assigning weights to the object-location information of differing ones of the multiple sensor-equipped vehicles based on sensor accuracy.

7. The method according to claim 4, further comprising assigning weights to the object-location information of differing ones of the multiple sensor-equipped vehicles based on sensor proximity to the one or more traffic objects.

8. The method according to claim 4, wherein a most-likely location of each of the one or more traffic objects is determined by averaging the object-location information from the multiple sensor-equipped vehicles.

9. The method according to claim 1, wherein multiple sensor-equipped vehicles provide object-location information from corresponding respective multiple sensor view angles of a group having a composition of two or more traffic objects, and generating a call signal includes determining the composition of the group as a function of the multiple sensor view angles.

10. The method according to claim 9, wherein executing one or more traffic-object-state algorithms includes using order and/or orientation of one or more traffic objects in the group to confirm that the object-location information from the multiple sensor view angles is referring to the same traffic object(s).

11. The method according to claim 1, wherein executing one or more traffic-object-state algorithms comprises includes determining likely direction of travel of the at least one of the one or more traffic objects and using the likely direction of travel to determine whether to give the at least one of the one or more traffic objects priority.

12. The method according to claim 11, wherein determining likely direction of travel includes determining which direction that at least one traffic object is facing.

13. The method according to claim 11, wherein determining likely direction of travel include determining a velocity vector for the at least one of the one or more traffic objects.

14. The method according to claim 1, wherein executing one or more AI algorithms includes determining presence of a jaywalker and generating the call signal to give travel priority to the jaywalker.

15. The method according to claim 1, further comprising:
processing, using the one or more AI algorithms, the object-location information to determine whether a transgression has occurred;
when the one or more AI algorithms have determined a transgression has occurred, generating a transgression notification that includes a location of the transgression; and
sending the transgression notification to an assistance authority.

16. The method according to claim 15, wherein the assistance authority is law enforcement, fire services, or emergency services, and the like.

17. The method according to claim 15, wherein the transgression is an accident.

18. The method according to claim 15, wherein the transgression notification includes an image relating to the transgression.

19. A machine-readable storage medium containing machine-executable instructions for performing a method of controlling a signalized traffic intersection based on presence of one or more traffic objects in proximity to the signalized traffic intersection, wherein the signalized traffic intersection includes a plurality of traffic signals controlled by a traffic signal controller, the method comprising:
continually obtaining object-location information based on sensor data from sensors located onboard one or more sensor-equipped vehicles in proximity to the signalized traffic intersection, wherein the object-location information contains information locating one or more traffic objects at or proximate to the signalized traffic intersection;
executing one or more traffic-object-state algorithms that use the object-location information for each of the one or more traffic objects and an object classification for each of the one or more traffic objects to determine a current state of at least one of the one or more traffic objects;
executing a travel-prioritization algorithm to determine whether to give at least one of the one or more traffic objects travel priority;
when the travel-prioritization algorithm has determined that travel priority should be given to at least one of the one or more traffic objects, generating a call signal configured to cause the traffic signal controller to control the plurality of traffic signals to give the travel priority to the at least one of the one or more traffic objects; and
transmitting the call signal to the traffic signal controller.

20. A method of determining a location of an object via a plurality of vehicles in proximity to the object, the method comprising:
sensing presence of the object using one or more first sensors located onboard a first vehicle of the plurality of vehicles;
generating first object-location data for the object based on the sensing of the object;
receiving, from at least one second vehicle of the plurality of vehicles, second object-location data for the object generated onboard the at least one second vehicle based on sensing of the presence of the object by one or more second sensors aboard the at least one second vehicle;
determining best-location data for the object using the first object-location data and the second object-location data; and
sharing the best-location data among the plurality of vehicles.
